(19) United States
(12) Patent Application Publication
(10) Pub. No.: US 2026/0062857 A1
(43) Pub. Date: Mar. 5, 2026

(54) TIDYING ROBOT FOR LAUNDRY WASHER AND DRYER

(71) Applicant: Clutterbot, Inc., Claymont, DE (US)

(72) Inventor: Justin David Hamilton, Wellington (NZ)

(73) Assignee: Clutterbot, Inc., Claymont, DE (US)

(21) Appl. No.: 19/315,298

(22) Filed: Aug. 29, 2025

Related U.S. Application Data
(60) Provisional application No. 63/688,623, filed on Aug. 29, 2024.

(51) Int. Cl. D06F 95/00; B25J 11/00; D06F 34/05

(52) U.S. Cl. CPC D06F 95/00; B25J 11/008; D06F 34/05

(57) ABSTRACT

A method is described for using a tidying robot to deliver items of clothing to a washing machine and a dryer. The robot approaches the washing machine, opens the door, and places the clothing inside. After the wash cycle is complete, the robot transfers the washed items of clothing to the dryer, opens the dryer door, and places the clothing inside. After the clothing has dried, the robot and carries it to a desired location. The robot also includes a clothes gathering routine to separate and pick up clothing items from a pile on the surface.

This application claims the benefit of U.S. provisional patent application Ser. No. 63/688,623, filed on Aug. 29, 2024, the contents of which are incorporated herein by reference in their entirety.

### BACKGROUND

Obstructions or objects underfoot represent not only a nuisance but also a safety hazard. Thousands of people each year are injured in a fall at home. A floor cluttered with loose objects may represent a danger, but many people have limited time in which to address the clutter in their homes. Automated cleaning or tidying robots may represent an effective solution.

Tidying robots conventionally organize objects into standard categories based on an object's type and other attributes that may be determined with classification. However, conventional robotic tidying solutions may be limited in their capabilities, and may be unable to autonomously complete a comprehensive cleaning operation without additional manual work by the user.

There is, therefore, a need for a general purpose tidying robot capable of complex and comprehensive housework operations.

A method for loading a washing machine with clothing involves a tidying robot that approaches the washing machine with a scoop. The tidying robot includes various components, such as wheels or tracks for mobility, a scoop for carrying items of clothing, pusher pads for grasping clothing, and a gripper arm for opening the washing machine door. The tidying robot performs a series of actions to load the washing machine, including grasping the door handle, opening the door, moving the scoop to the door opening, placing clothing in the scoop, and closing the door.

The steps of the method involve approaching the washing machine with the tidying robot, grasping the door handle with the gripper arm, opening the door, and then moving the scoop into position to place clothing in the washing machine.

In some embodiments, the method for utilizing the tidying robot in the process of washing and drying clothes may also include a clothes gathering routine. This routine involves using pusher pads to separate and gather clothing items from a pile on a surface. The process includes grasping, moving, and releasing the clothing items using the pusher pads. The pusher pad arms are extended and retracted to facilitate the movement of the clothing items onto a scoop of the tidying robot.

In some embodiments, the method further comprises a sequence of actions related to drying the washed laundry. Specifically, the method may involve a series of steps to remove the washed items from the washing machine onto the scoop, open a dryer door, tilt the scoop into the dryer door opening, load the items into the dryer, remove the scoop, and close the dryer door.

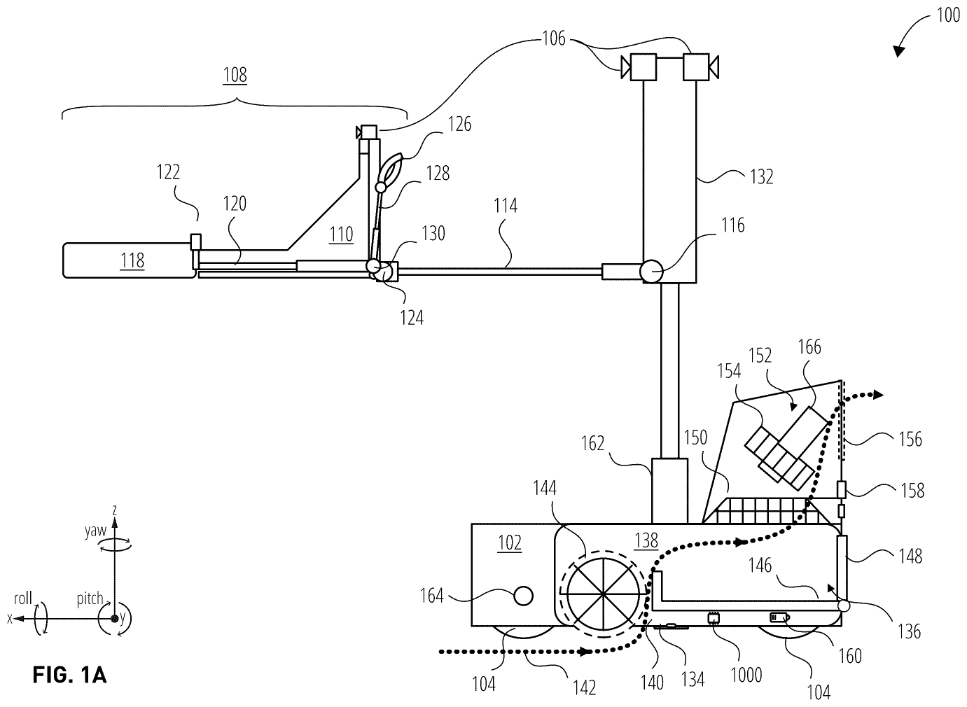

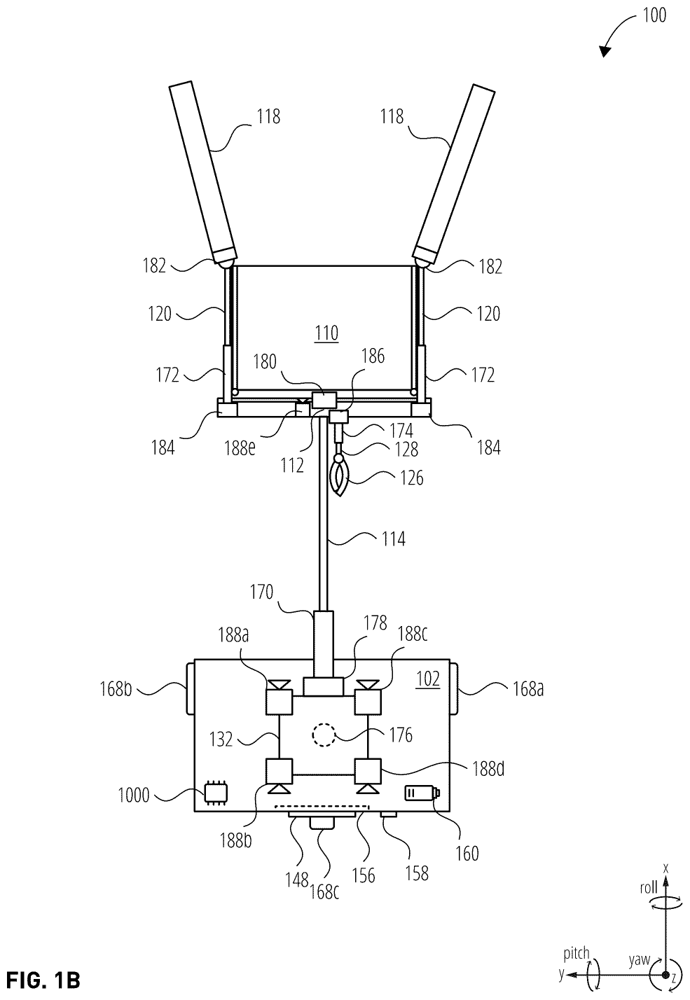

FIG. 1A and FIG. 1B illustrate a tidying robot 100 in accordance with one embodiment. FIG. 1A shows a side view and FIG. 1B shows a top view.

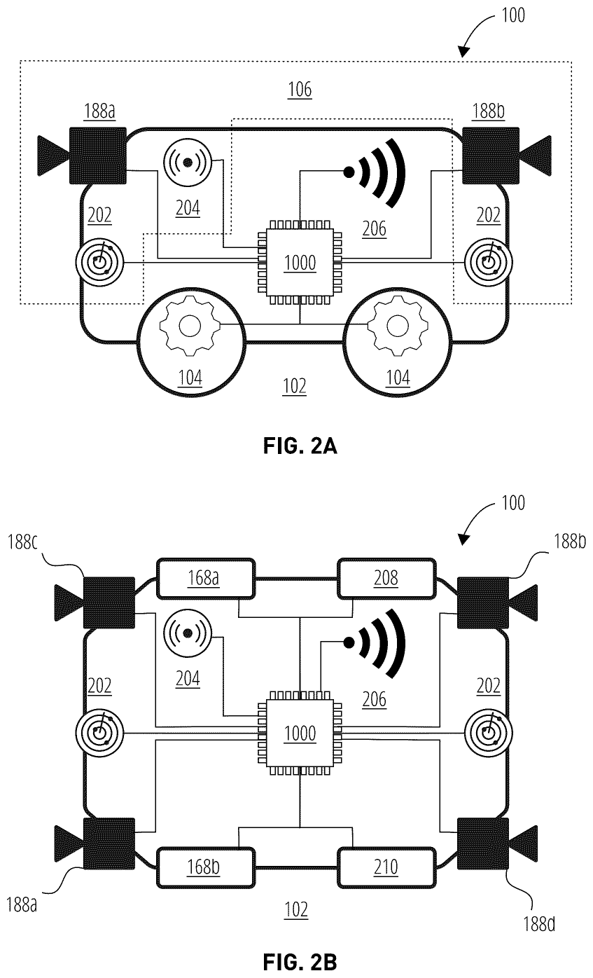

FIG. 2A and FIG. 2B illustrate a simplified side view and top view of a chassis 102 of the tidying robot 100, respectively.

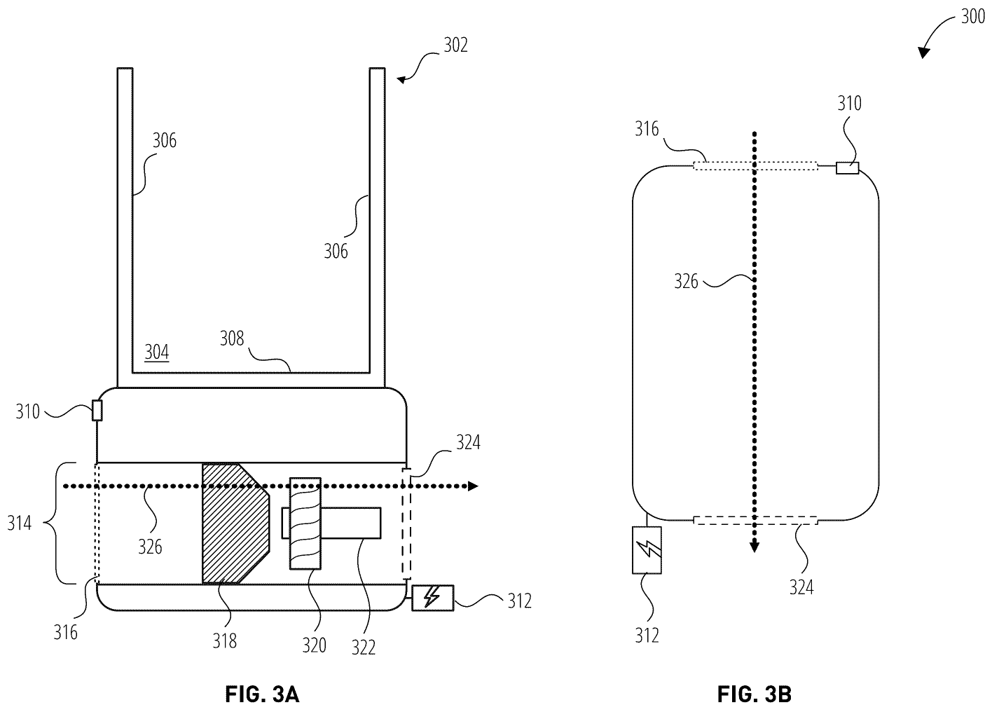

FIG. 3A and FIG. 3B illustrate a left side view and a top view of a base station 300, respectively, in accordance with one embodiment.

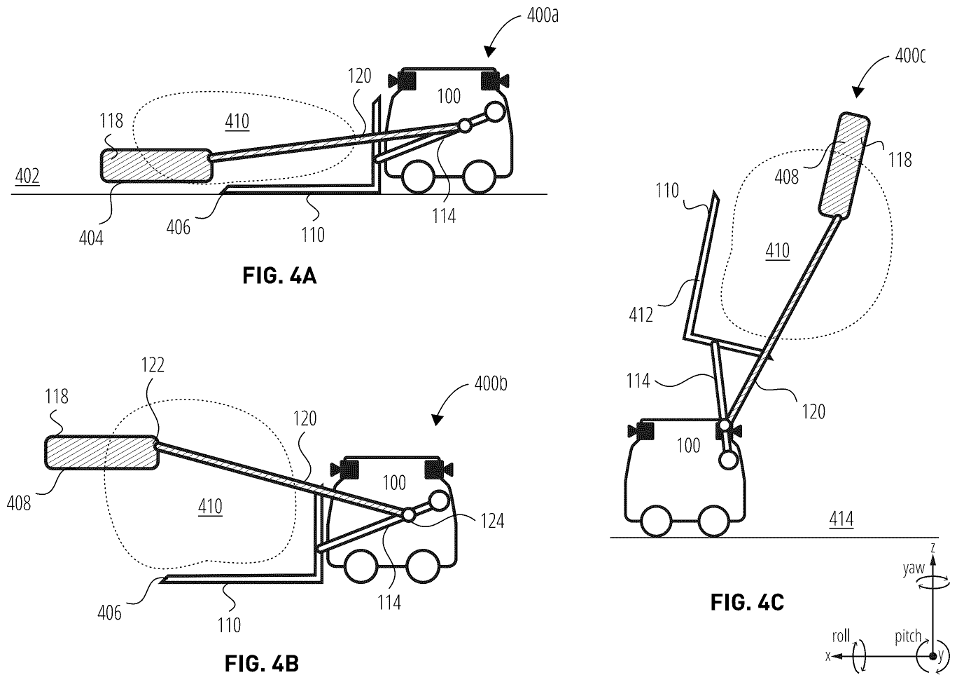

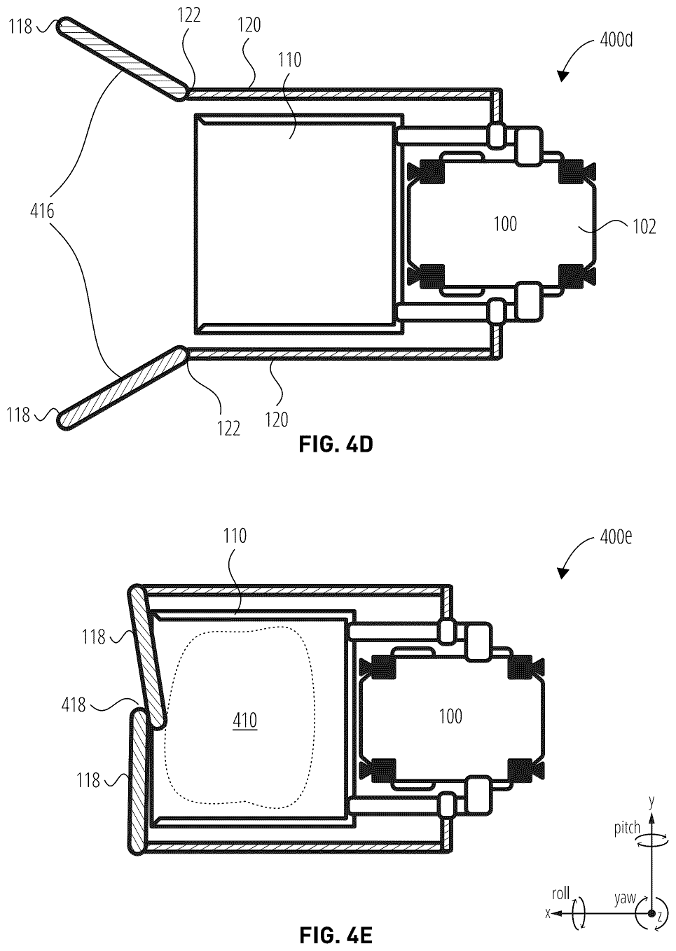

FIG. 4A illustrates a lowered scoop position and lowered pusher position 400a for the tidying robot 100 in accordance with one embodiment.

FIG. 4B illustrates a lowered scoop position and raised pusher position 400b for the tidying robot 100 in accordance with one embodiment.

FIG. 4C illustrates a raised scoop position and raised pusher position 400c for the tidying robot 100 in accordance with one embodiment.

FIG. 4D illustrates a tidying robot 100 with pusher pads extended 400d in accordance with one embodiment.

FIG. 4E illustrates a tidying robot 100 with pusher pads retracted 400e in accordance with one embodiment.

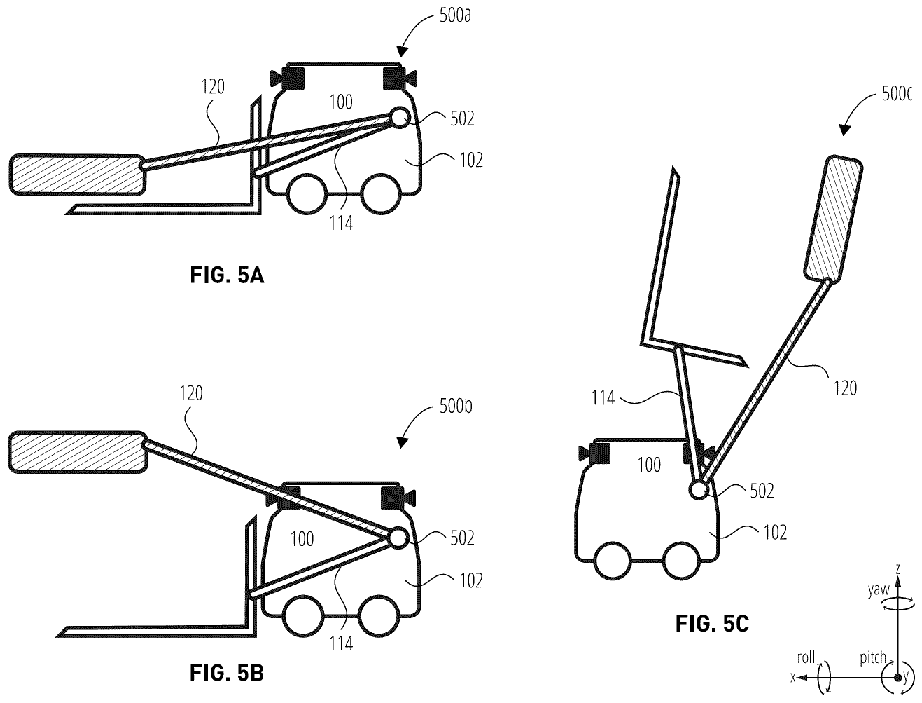

FIG. 5A illustrates a lowered scoop position and lowered pusher position 500a for the tidying robot 100 in accordance with one embodiment.

FIG. 5B illustrates a lowered scoop position and raised pusher position 500b for the tidying robot 100 in accordance with one embodiment.

FIG. 5C illustrates a raised scoop position and raised pusher position 500c for the tidying robot 100 in accordance with one embodiment.

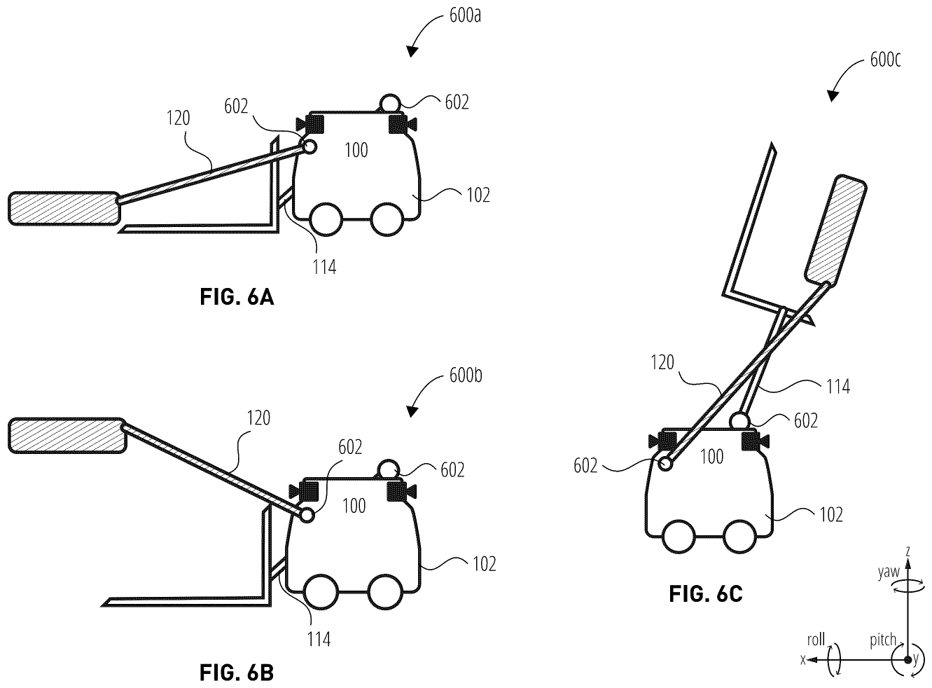

FIG. 6A illustrates a lowered scoop position and lowered pusher position 600a for the tidying robot 100 in accordance with one embodiment.

FIG. 6B illustrates a lowered scoop position and raised pusher position 600b for the tidying robot 100 in accordance with one embodiment.

FIG. 6C illustrates a raised scoop position and raised pusher position 600c for the tidying robot 100 in accordance with one embodiment.

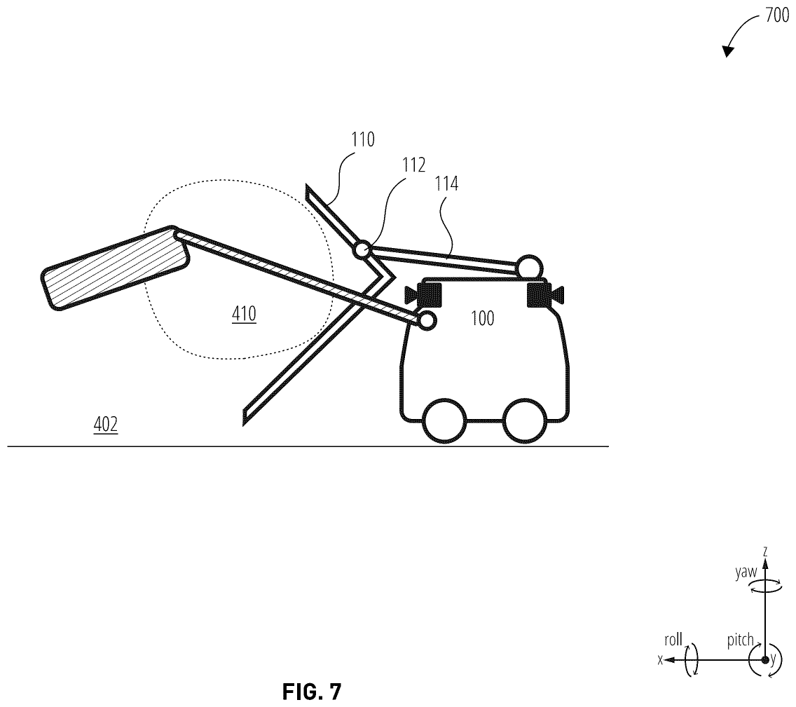

FIG. 7 illustrates a front dump action 800 for the tidying robot 100 in accordance with one embodiment.

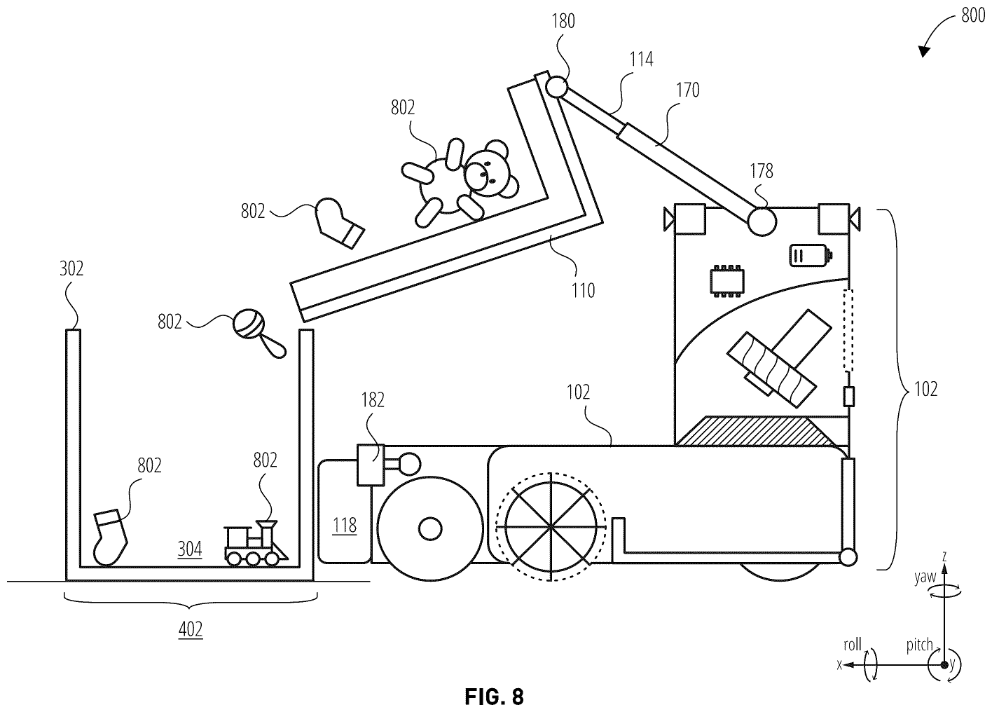

FIG. 8 illustrates a tidying robot 100 performing a front dump in accordance with one embodiment.

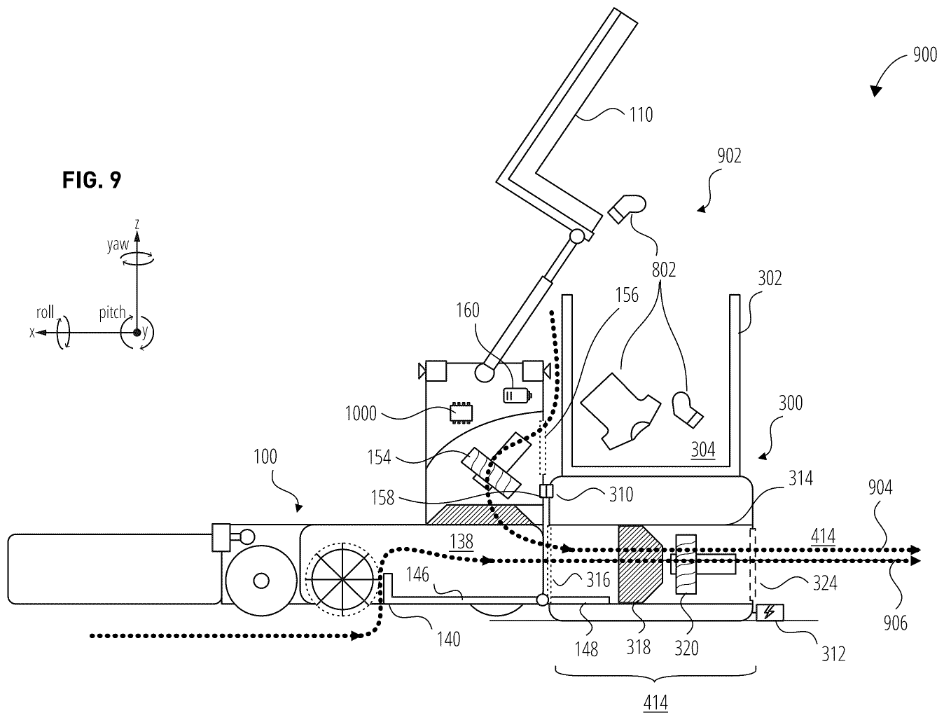

FIG. 9 illustrates a tidying robotic system interaction 900 in accordance with one embodiment.

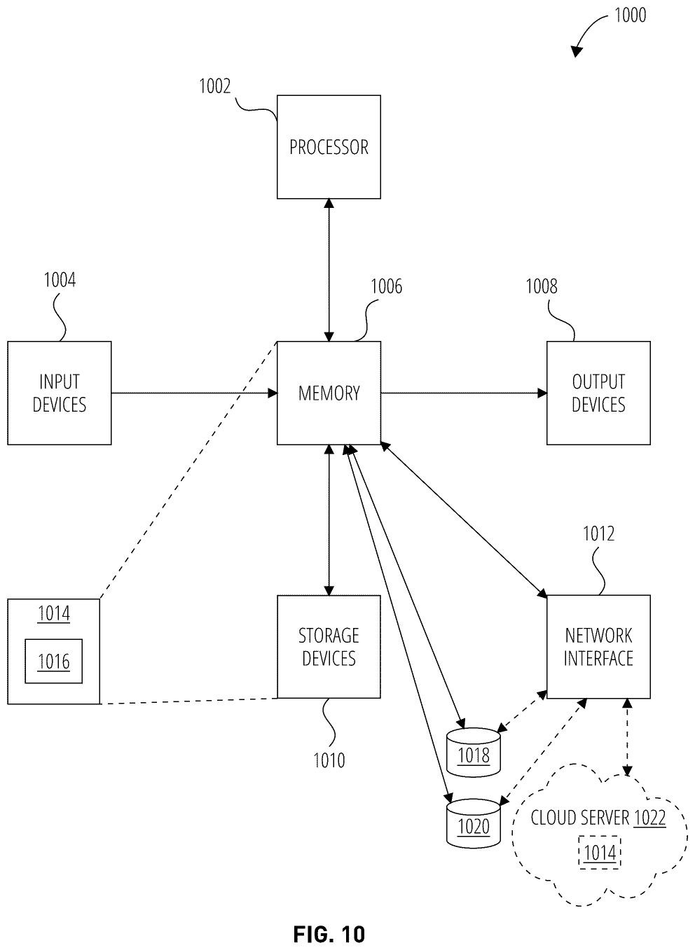

FIG. 10 illustrates an embodiment of a robotic control system 1000 to implement components and process steps of the system described herein.

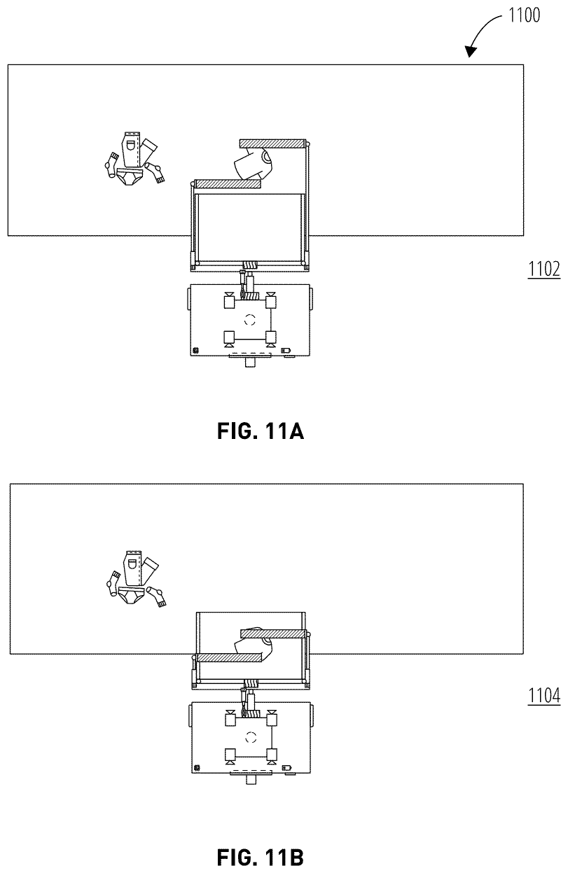

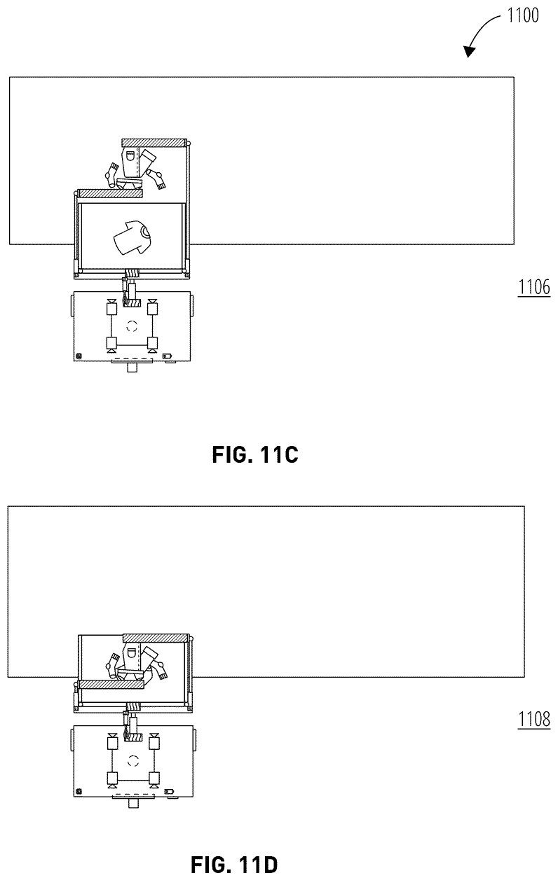

FIG. 11A to FIG. 11D illustrate a clothes gathering routine 1100 in accordance with one embodiment.

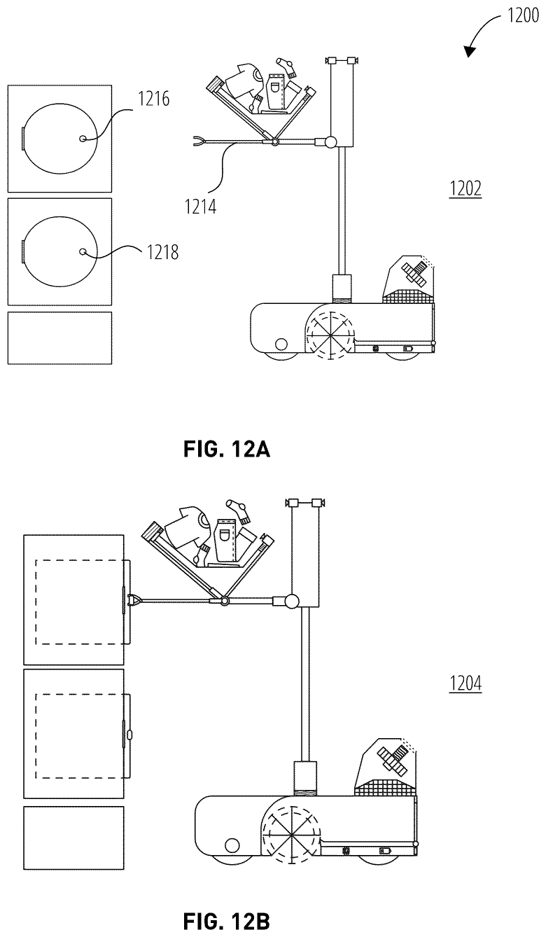

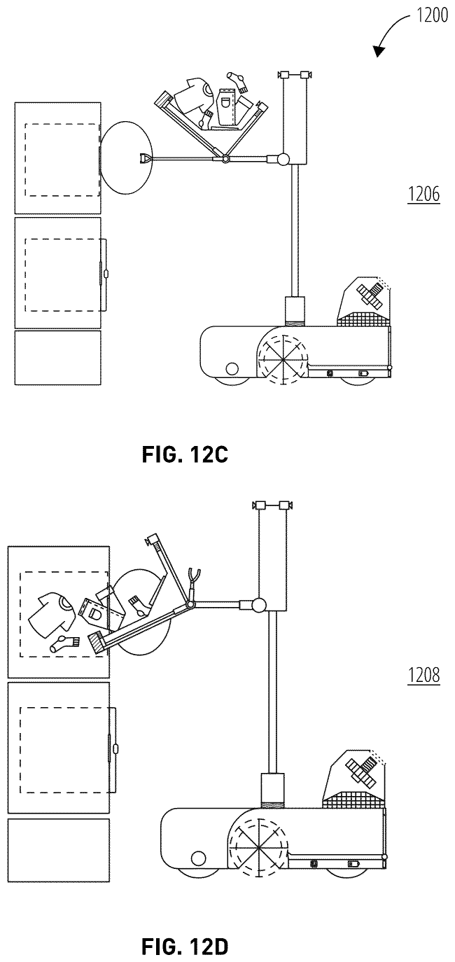

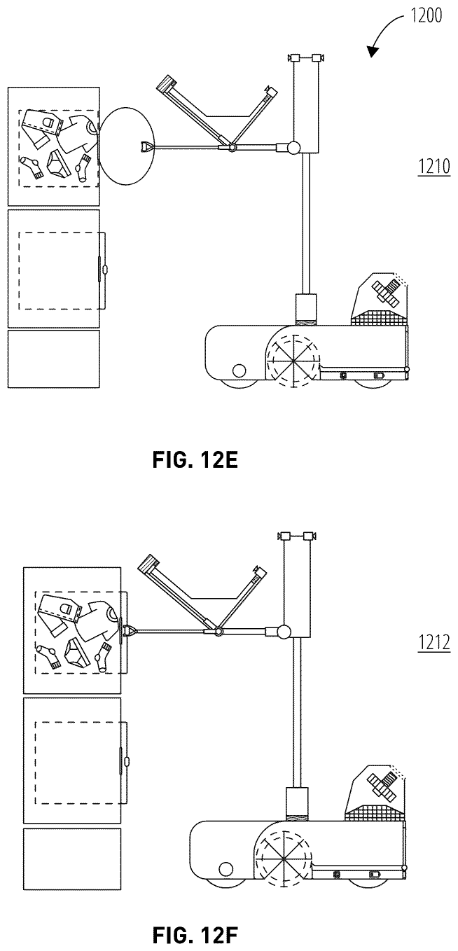

FIG. 12A to FIG. 12F illustrate a washer loading routine 1200 in accordance with one embodiment.

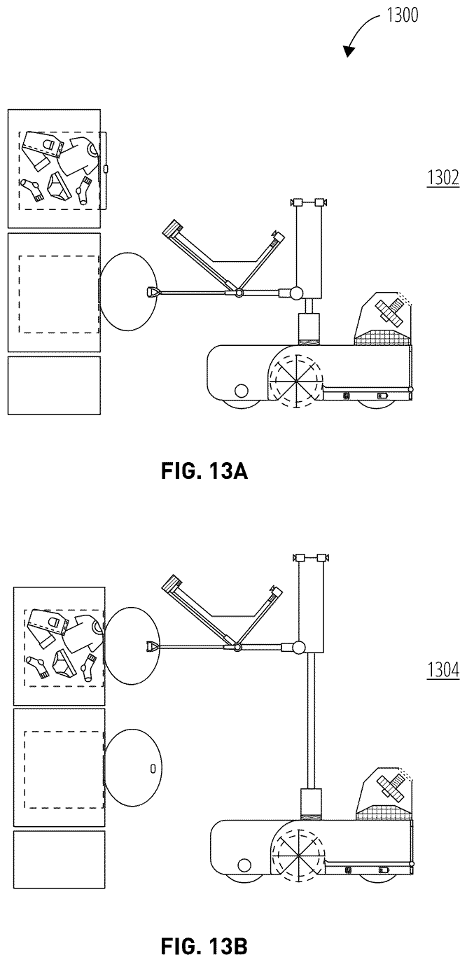

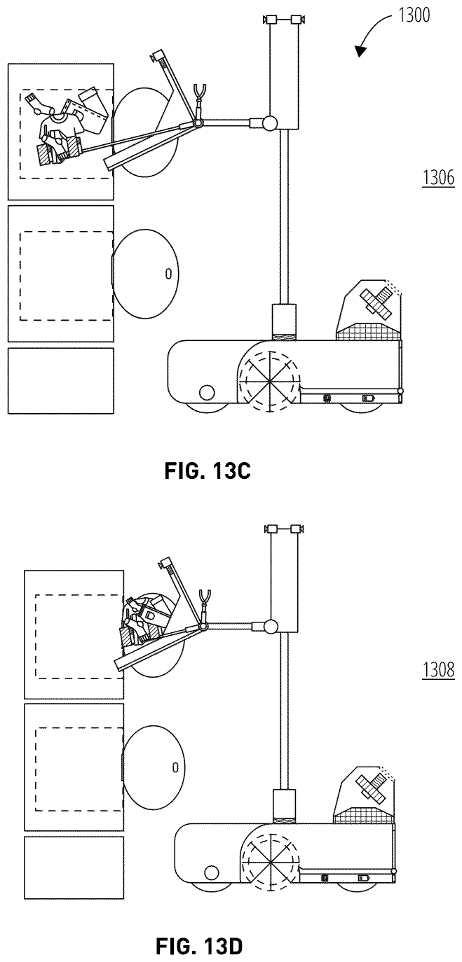

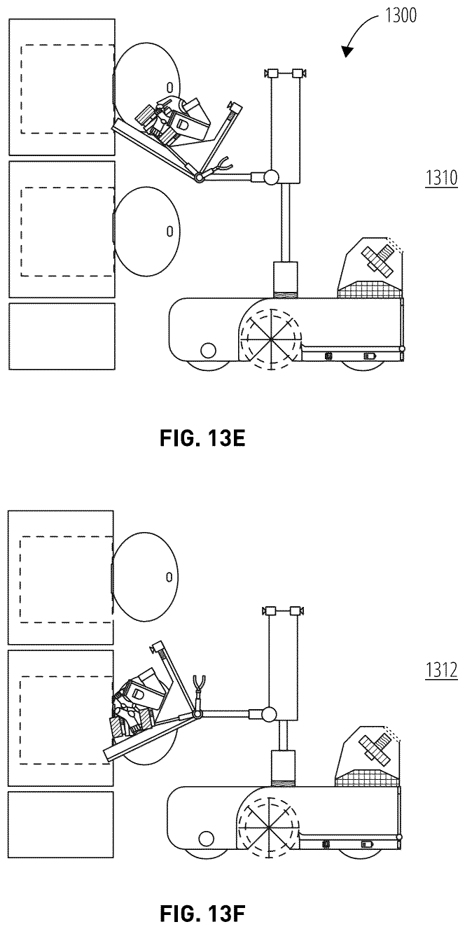

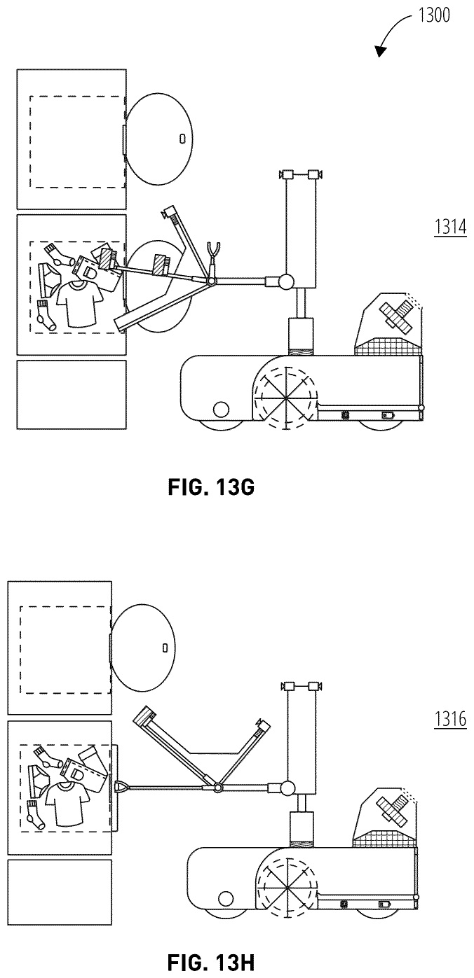

FIG. 13A to FIG. 13I illustrate a dryer loading routine 1300 in accordance with one embodiment.

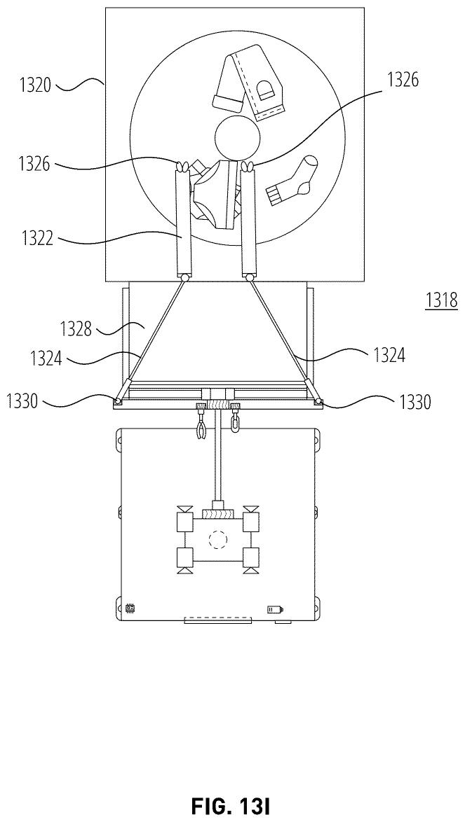

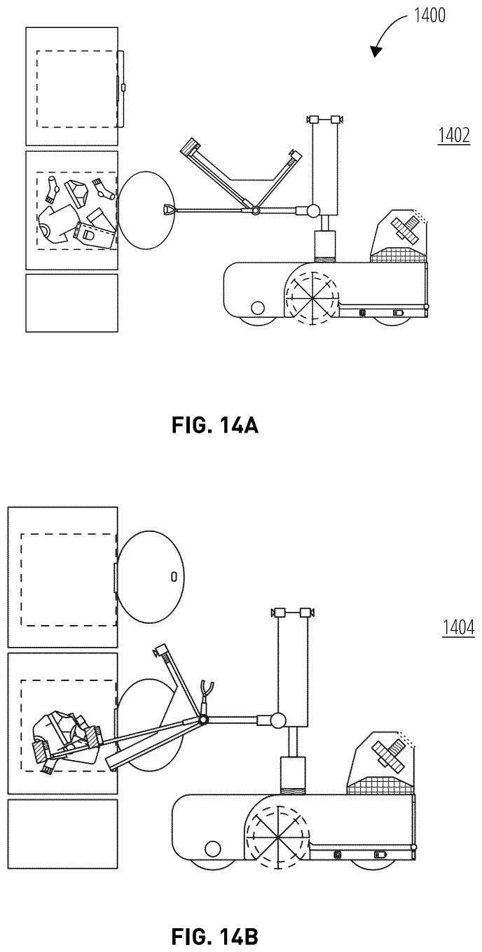

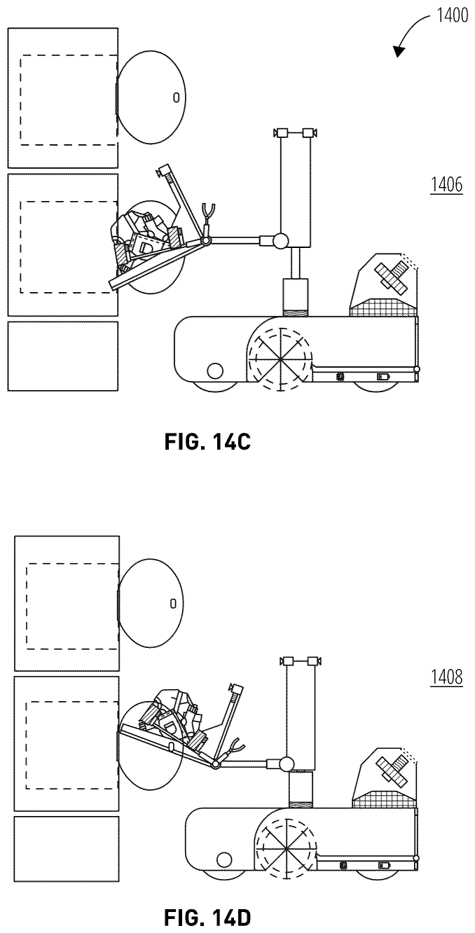

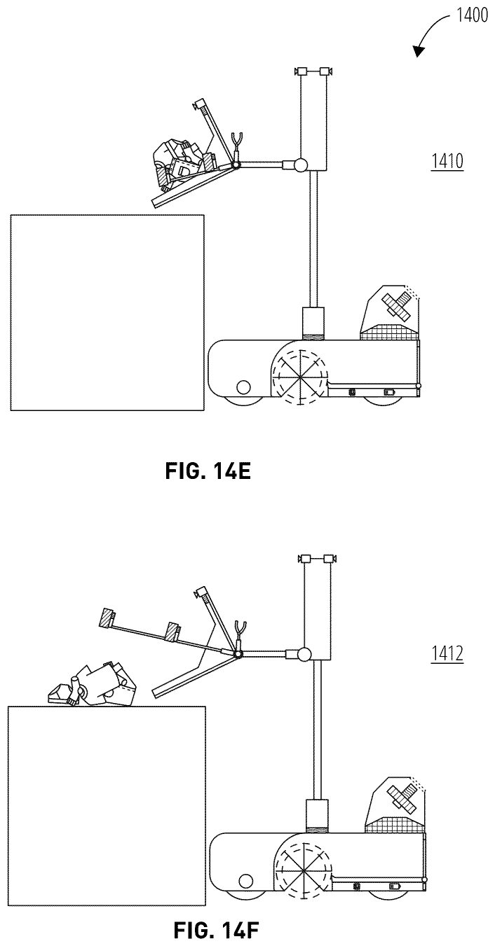

FIG. 14A to FIG. 14F illustrate a dryer unloading routine 1400 in accordance with one embodiment.

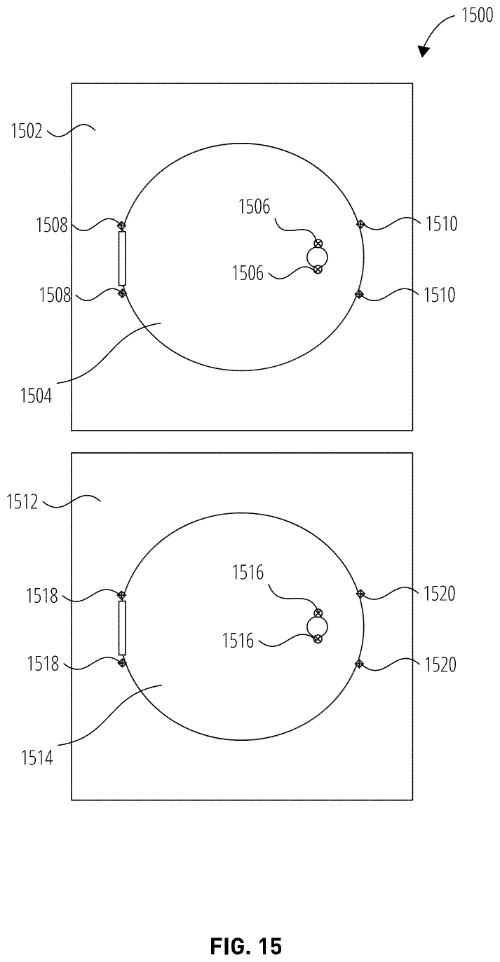

FIG. 15 illustrates a use of key point manipulation 1500 in accordance with one embodiment.

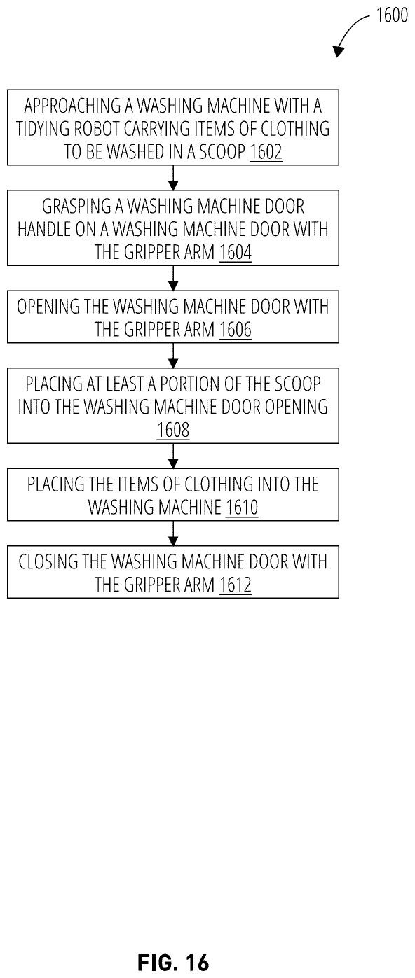

FIG. 16 illustrates a method 1600 in accordance with one embodiment.

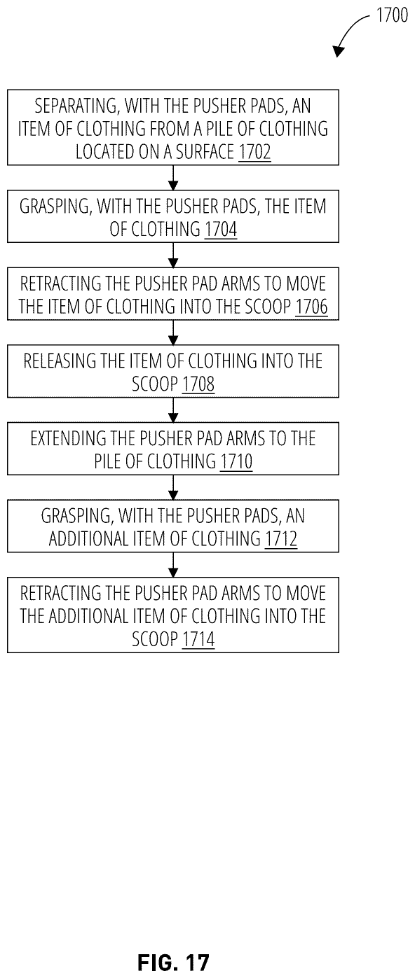

FIG. 17 illustrates a method 1700 in accordance with one embodiment.

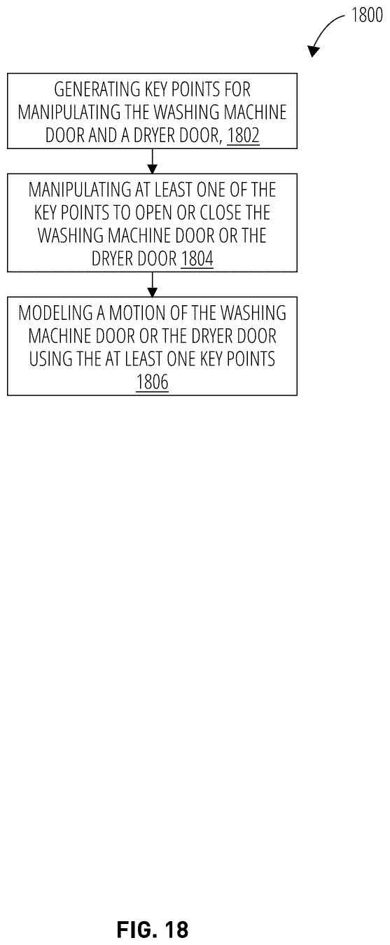

FIG. 18 illustrates a method 1800 in accordance with one embodiment.

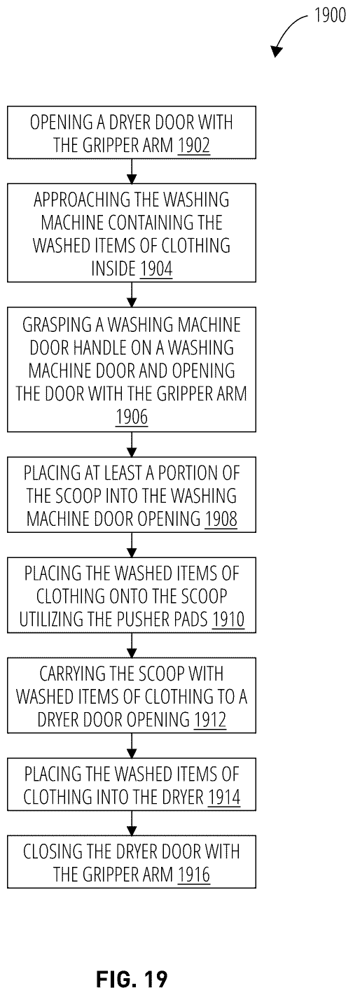

FIG. 19 illustrates a method 1900 in accordance with one embodiment.

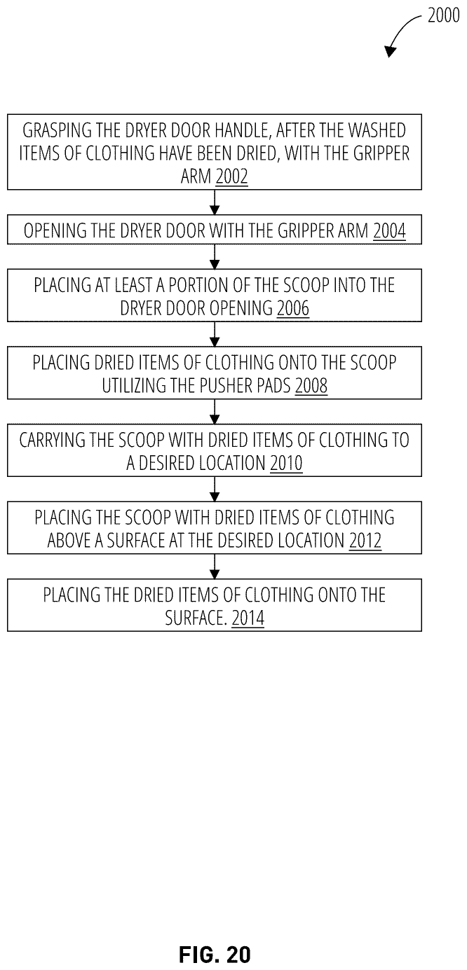

FIG. 20 illustrates a method 2000 in accordance with one embodiment.

### DETAILED DESCRIPTION

A General Purpose Tidying Robot may be configured with fabric grippers at the end of each pusher arm, such as a soft pinch-style gripper with a reasonably high friction with fabric. The tidying robot may thus be able to perform fabric manipulation tasks. Such a robot may be configured to collect laundry from a single location such as a hamper or from throughout an environment to be tidied. Collectable fabric items may include small items such as infant socks, or strappy or delicate items, such as intimates, and heavy or stiff items, such as denim outerwear. The tidying robot may be able to load these items into a washer, move clean wet items from washer to dryer, and unload from the washer to a hamper for clean items or to a counter for folding.

FIG. 1A-FIG. 2B illustrate a tidying robot 100 in accordance with one embodiment. FIG. 1A shows a side view and FIG. 1B shows a top view. The tidying robot 100 may comprise a chassis 102, a mobility system 104, a sensing system 106, a capture and containment system 108, and a robotic control system 1000. The capture and containment system 108 may further comprise a scoop 110, a scoop pivot point 112, a scoop arm 114, a scoop arm pivot point 116, two pusher pads 118 with pad pivot points 122, two pusher pad arms 120 with pad arm pivot points 124, an actuated gripper 126, a gripper arm 128 with a gripper pivot point 130, and a lifting column 132 to raise and lower the capture and containment system 108 to a desired height. In one embodiment, the gripper arm 128 may include features for gripping and/or gripping surfaces in lieu of or in addition to an actuated gripper 126.

The tidying robot 100 may further include a mop pad 134, and robot vacuum system 136. The robot vacuum system 136 may include a vacuum compartment 138, a vacuum compartment intake port 140, a cleaning airflow 142, a rotating brush 144, a dirt collector 146, a dirt release latch 148, a vacuum compartment filter 150, and a vacuum generating assembly 152 that includes a vacuum compartment fan 154, a vacuum compartment motor 166, and a vacuum compartment exhaust port 156. The tidying robot 100 may include a robot charge connector 158, a battery 160, and number of motors, actuators, sensors, and mobility components as described in greater detail below, and a robotic control system 1000 providing actuation signals based on sensor signals and user inputs.

The chassis 102 may support and contain the other components of the tidying robot 100. The mobility system 104 may comprise wheels as indicated, as well as caterpillar tracks, conveyor belts, etc., as is well understood in the art. The mobility system 104 may further comprise motors, servos, or other sources of rotational or kinetic energy to impel the tidying robot 100 along its desired paths. Mobility system 104 components may be mounted on the chassis 102 for the purpose of moving the entire robot without impeding or inhibiting the range of motion needed by the capture and containment system 108. Elements of a sensing system 106, such as cameras, lidar sensors, or other components, may be mounted on the chassis 102 in positions giving the tidying robot 100 clear lines of sight around its environment in at least some configurations of the chassis 102, scoop 110, pusher pad 118, and pusher pad arm 120 with respect to each other.

The chassis 102 may house and protect all or portions of the robotic control system 1000, (portions of which may also be accessed via connection to a cloud server) comprising in some embodiments a processor, memory, and connections to the mobility system 104, sensing system 106, and capture and containment system 108. The chassis 102 may contain other electronic components such as batteries 160, wireless communications 206 devices, etc., as is well understood in the art of robotics. The robotic control system 1000 may function as described in greater detail with respect to FIG. 10. The mobility system 104 and or the robotic control system 1000 may incorporate motor controllers used to control the speed, direction, position, and smooth movement of the motors. Such controllers may also be used to detect force feedback and limit maximum current (provide overcurrent protection) to ensure safety and prevent damage.

The capture and containment system 108 may comprise a scoop 110 with an associated scoop motor 180 to rotate the scoop 110 into different positions at the scoop pivot point 112. The capture and containment system 108 may also include a scoop arm 114 with an associated scoop arm motor 178 to rotate the scoop arm 114 into different positions around the scoop arm pivot point 116, and a scoop arm linear actuator 170 to extend the scoop arm 114. Pusher pads 118 of the capture and containment system 108 may have pusher pad motors 182 to rotate them into different positions around the pad pivot points 122. Pusher pad arms 120 may be associated with pusher pad arm motors 184 that rotate them around pad arm pivot points 124, as well as pusher pad arm linear actuators 172 to extend and retract the pusher pad arms 120. The gripper arm 128 may include a gripper arm motor 186 to move the gripper arm 128 around a gripper pivot point 130, as well as a gripper arm linear actuator 174 to extend and retract the gripper arm 128. In this manner the gripper arm 128 may be able to move and position itself and/or the actuated gripper 126 to perform the tasks disclosed herein.

Points of connection shown herein between the scoop arms and pusher pad arms are exemplary positions and are not intended to limit the physical location of such points of connection. Such connections may be made in various locations as appropriate to the construction of the chassis and arms, and the applications of intended use. In some embodiments, the pusher pad arms 120 may attach to the scoop 110, as shown here. In other embodiments, the pusher pad arm 120 may attach to the chassis 102 as shown, for example, in FIG. 5A or FIG. 8. It will be well understood by one of ordinary skill in the art that the configurations illustrated may be designed to perform the basic motions described with respect to FIG. 4A-FIG. 9 and the processes illustrated elsewhere herein.

The geometry of the scoop 110 and the disposition of the pusher pads 118 and pusher pad arms 120 with respect to the scoop 110 may describe a containment area, illustrated more clearly in FIG. 4A-FIG. 4E, in which objects may be securely carried. Servos, direct current (DC) motors, or other actuators at the scoop arm pivot point 116, pad pivot points 122, and pad arm pivot points 124 may be used to adjust the disposition of the scoop 110, pusher pads 118, and pusher pad arms 120 between fully lowered scoop and grabber positions and raised scoop and grabber positions, as illustrated with respect to FIG. 4A-FIG. 4C.

In some embodiments, gripping surfaces may be configured on the sides of the pusher pads 118 facing inward toward objects to be lifted. These gripping surfaces may provide cushion, grit, elasticity, or some other feature that increases friction between the pusher pads 118 and objects to be captured and contained. In some embodiments, the pusher pad 118 may include suction cups in order to better grasp objects having smooth, flat surfaces. In some embodiments, the pusher pads 118 may be configured with sweeping bristles. These sweeping bristles may assist in moving small objects from the floor up onto the scoop 110. In some embodiments, the sweeping bristles may angle down and inward from the pusher pads 118, such that, when the pusher pads 118 sweep objects toward the scoop 110, the sweeping bristles form a ramp, allowing the foremost bristles to slide beneath the object, and direct the object upward toward the pusher pads 118, facilitating capture of the object within the scoop and reducing a tendency of the object to be pressed against the floor, increasing its friction and making it more difficult to move.

The capture and containment system 108, as well as some portions of the sensing system 106, may be mounted atop a lifting column 132, such that these components may be raised and lowered with respect to the ground to facilitate performance of complex tasks. A lifting column linear actuator 162 may control the elevation of the capture and containment system 108 by extending and retracting the lifting column 132. A lifting column motor 176 may allow the lifting column 132 to rotate so that the capture and containment system 108 may be moved with respect to the tidying robot 100 base or chassis 102 in all three dimensions.

The tidying robot 100 may include floor cleaning components such as a mop pad 134 and a vacuuming system. The mop pad 134 may be able to raise and lower with respect to the bottom of the tidying robot 100 chassis 102, so that it may be placed in contact with the floor when desired. The mop pad 134 may include a drying element to dry wet spots detected on the floor. In one embodiment, the tidying robot 100 may include a fluid reservoir, which may be in contact with the mop pad 134 and able to dampen the mop pad 134 for cleaning. In one embodiment, the tidying robot 100 may be able to spray cleaning fluid from a fluid reservoir onto the floor in front of or behind the tidying robot 100, which may then be absorbed by the mop pad 134.

The vacuuming system may include a vacuum compartment 138, which may have a vacuum compartment intake port 140 allowing cleaning airflow 142 into the vacuum compartment 138. The vacuum compartment intake port 140 may be configured with a rotating brush 144 to impel dirt and dust into the vacuum compartment 138. Cleaning airflow 142 may be induced to flow by a vacuum compartment fan 154 powered by a vacuum compartment motor 166. cleaning airflow 142 may pass through the vacuum compartment 138 from the vacuum compartment intake port 140 to a vacuum compartment exhaust port 156, exiting the vacuum compartment 138 at the vacuum compartment exhaust port 156. The vacuum compartment exhaust port 156 may be covered by a grating or other element permeable to cleaning airflow 142 but able to prevent the ingress of objects into the chassis 102 of the tidying robot 100.

A vacuum compartment filter 150 may be disposed between the vacuum compartment intake port 140 and the vacuum compartment exhaust port 156. The vacuum compartment filter 150 may prevent dirt and dust from entering and clogging the vacuum compartment fan 154. The vacuum compartment filter 150 may be disposed such that blocked dirt and dust are deposited within a dirt collector 146. The dirt collector 146 may be closed off from the outside of the chassis 102 by a dirt release latch 148. The dirt release latch 148 may be configured to open when the tidying robot 100 is docked at a base station 300 with a vacuum emptying system 314, as is illustrated in FIG. 3A and FIG. 3B and described below. A robot charge connector 158 may connect the tidying robot 100 to a base station charge connector 310, allowing power from the base station 300 to charge the tidying robot 100 battery 160.

FIG. 2A and FIG. 2B illustrate a simplified side view and top view of a chassis 102, respectively, in order to show in more detail aspects of the mobility system 104, the sensing system 106, and the communications 206, in connection with the robotic control system 1000. In some embodiments, the communications 206 may include the network interface 1012 described in greater detail with respect to robotic control system 1000.

In one embodiment, the mobility system 104 may comprise a left front wheel 168b and a right front wheel 168a powered by mobility system motor 164, and a single rear wheel 168c, as illustrated in FIG. 1A and FIG. 1B. The single rear wheel 168c may be actuated or may be a passive roller or caster providing support and reduced friction with no driving force.

In one embodiment, the mobility system 104 may comprise a right front wheel 168a, a left front wheel 168b, a right rear wheel 208, and a left rear wheel 210. The tidying robot 100 may have front-wheel drive, where right front wheel 168a and left front wheel 168b are actively driven by one or more actuators or motors, while the right rear wheel 208 and left rear wheel 210 spin on an axle passively while supporting the rear portion of the chassis 102. In another embodiment, the tidying robot 100 may have rear-wheel drive, where the right rear wheel 208 and left rear wheel 210 are actuated and the front wheels turn passively. In another embodiment, the tidying robot 100 may have additional motors to provide all-wheel drive, may use a different number of wheels, or may use caterpillar tracks or other mobility devices in lieu of wheels.

The sensing system 106 may further comprise cameras such as the front left camera 188a, rear left camera 188b, front right camera 188c, rear right camera 188d, and scoop camera 188e, light detecting and ranging (LIDAR) sensors such as lidar sensors 202, and inertial measurement unit (IMU) sensors, such as IMU sensors 204. In some embodiments, there may be a single front camera and a single rear camera.

FIG. 3A and FIG. 3B illustrate a base station 300 in accordance with one embodiment. FIG. 3A shows a left side view and FIG. 3B shows a top view. The base station 300 may comprise an object collection bin 302 with a storage compartment 304 to hold tidyable objects, heavy dirt and debris, or other obstructions. The storage compartment 304 may be formed by bin sides 306 and a bin base 308. “Tidyable objects” in this disclosure are elements detected in the environment that may be moved by the robot and put away in a home location. These objects may be of a type and size such that the robot may autonomously put them away, such as toys, clothing, books, stuffed animals, soccer balls, garbage, remote controls, keys, cellphones, etc. The base station 300 may further comprise a base station charge connector 310, a power source connection 312, and a vacuum emptying system 314 including a vacuum emptying system intake port 316, a vacuum emptying system filter bag 318, a vacuum emptying system fan 320, a vacuum emptying system motor 322, and a vacuum emptying system exhaust port 324.

The object collection bin 302 may be configured on top of the base station 300 so that a tidying robot 100 may deposit objects from the scoop 110 into the object collection bin 302. The base station charge connector 310 may be electrically coupled to the power source connection 312. The power source connection 312 may be a cable connector configured to couple through a cable to an alternating current (AC) or direct current (DC) source, a battery, or a wireless charging port, as will be readily apprehended by one of ordinary skill in the art. In one embodiment, the power source connection 312 is a cable and male connector configured to couple with 120V AC power, such as may be provided by a conventional U. S. home power outlet.

The vacuum emptying system 314 may include a vacuum emptying system intake port 316 allowing vacuum emptying airflow 326 into the vacuum emptying system 314. The vacuum emptying system intake port 316 may be configured with a flap or other component to protect the interior of the vacuum emptying system 314 when a tidying robot 100 is not docked. A vacuum emptying system filter bag 318 may be disposed between the vacuum emptying system intake port 316 and a vacuum emptying system fan 320 to catch dust and dirt carried by the vacuum emptying airflow 326 into the vacuum emptying system 314. The vacuum emptying system fan 320 may be powered by a vacuum emptying system motor 322. The vacuum emptying system fan 320 may pull the vacuum emptying airflow 326 from the vacuum emptying system intake port 316 to the vacuum emptying system exhaust port 324, which may be configured to allow the vacuum emptying airflow 326 to exit the vacuum emptying system 314. The vacuum emptying system exhaust port 324 may be covered with a grid to protect the interior of the vacuum emptying system 314.

FIG. 4A illustrates a tidying robot 100 such as that introduced with respect to FIG. 1A disposed in a lowered scoop position and lowered pusher position 400a. In this configuration, the pusher pads 118 and pusher pad arms 120 rest in a lowered pusher position 404, and the scoop 110 and scoop arm 114 rest in a lowered scoop position 406 at the front 402 of the tidying robot 100. In this position, the scoop 110 and pusher pads 118 may roughly describe a containment area 410 as shown.

FIG. 4B illustrates a tidying robot 100 with a lowered scoop position and raised pusher position 400b. Through the action of servos or other actuators at the pad pivot points 122 and pad arm pivot points 124, the pusher pads 118 and pusher pad arms 120 may be raised to a raised pusher position 408 while the scoop 110 and scoop arm 114 maintain a lowered scoop position 406. In this configuration, the pusher pads 118 and scoop 110 may roughly describe a containment area 410 as shown, in which an object taller than the scoop 110 height may rest within the scoop 110 and be held in place through pressure exerted by the pusher pads 118.

Pad arm pivot points 124, pad pivot points 122, scoop arm pivot points 116 and scoop pivot points 112 (as shown in FIG. 7) may provide the tidying robot 100 a range of motion of these components beyond what is illustrated herein. The positions shown in the disclosed figures are illustrative and not meant to indicate the limits of the robot's component range of motion.

FIG. 4C illustrates a tidying robot 100 with a raised scoop position and raised pusher position 400c. The pusher pads 118 and pusher pad arms 120 may be in a raised pusher position 408 while the scoop 110 and scoop arm 114 are in a raised scoop position 412. In this position, the tidying robot 100 may be able to allow objects drop from the scoop 110 and pusher pad arms 120 to an area at the rear 414 of the tidying robot 100.

The carrying position may involve the disposition of the pusher pads 118, pusher pad arms 120, scoop 110, and scoop arm 114, in relative configurations between the extremes of lowered scoop position and lowered pusher position 400a and raised scoop position and raised pusher position 400c.

FIG. 4D illustrates a tidying robot 100 with pusher pads extended 400d. By the action of servos or other actuators at the pad pivot points 122, the pusher pads 118 may be configured as extended pusher pads 416 to allow the tidying robot 100 to approach objects as wide or wider than the robot chassis 102 and scoop 110. In some embodiments, the pusher pads 118 may be able to rotate through almost three hundred and sixty degrees, to rest parallel with and on the outside of their associated pusher pad arms 120 when fully extended.

FIG. 4E illustrates a tidying robot 100 with pusher pads retracted 400c. The closed pusher pads 418 may roughly define a containment area 410 through their position with respect to the scoop 110. In some embodiments, the pusher pads 118 may be able to rotate farther than shown, through almost three hundred and sixty degrees, to rest parallel with and inside of the side walls of the scoop 110.

FIG. 5A-FIG. 5C illustrate a tidying robot 100 such as that introduced with respect to FIG. 1A. In such an embodiment, the pusher pad arms 120 may be controlled by a servo or other actuator at the same point of connection 502 with the chassis 102 as the scoop arms 114. The tidying robot 100 may be seen disposed in a lowered scoop position and lowered pusher position 500a, a lowered scoop position and raised pusher position 500b, and a raised scoop position and raised pusher position 500c. This tidying robot 100 may be configured to perform the algorithms disclosed herein.

The point of connection shown between the scoop arms 114/pusher pad arms 120 and the chassis 102 is an exemplary position and is not intended to limit the physical location of this point of connection. Such connection may be made in various locations as appropriate to the construction of the chassis 102 and arms, and the applications of intended use.

FIG. 6A-FIG. 6C illustrate a tidying robot 100 such as that introduced with respect to FIG. 1A. In such an embodiment, the pusher pad arms 120 may be controlled by a servo or servos (or other actuators) at different points of connection 602 with the chassis 102 from those controlling the scoop arm 114. The tidying robot 100 may be seen disposed in a lowered scoop position and lowered pusher position 600a, a lowered scoop position and raised pusher position 600b, and a raised scoop position and raised pusher position 600c. This tidying robot 100 may be configured to perform the algorithms disclosed herein.

The different points of connection 602 between the scoop arm and chassis and the pusher pad arms and chassis shown are exemplary positions and not intended to limit the physical locations of these points of connection. Such connections may be made in various locations as appropriate to the construction of the chassis and arms, and the applications of intended use.

FIG. 7 illustrates a tidying robot 100 such as was previously introduced in a front drop position 700. The arms of the tidying robot 100 may be positioned to form a containment area 410 as previously described.

The tidying robot 100 may be configured with a scoop pivot point 112 where the scoop 110 connects to the scoop arm 114. The scoop pivot point 112 may allow the scoop 110 to be tilted forward and down while the scoop arm 114 is raised, allowing objects in the containment area 410 to slide out and be deposited in an area to the front 402 of the tidying robot 100.

FIG. 8 illustrates how the positions of the components of the tidying robot 100 may be configured such that the tidying robot 100 may approach an object collection bin 302 and perform a front dump action 800. The scoop 110 may be raised by scoop arm motor 178, extended by scoop arm linear actuator 170, and tilted by scoop motor 180 so that tidyable objects 802 carried in the scoop 110 may be deposited into the storage compartment 304 of the object collection bin 302 positioned to the front 402 of the tidying robot 100, as is also described with respect to the front drop position 700 of FIG. 7.

FIG. 9 illustrates a tidying robotic system interaction 900 in accordance with one embodiment. The tidying robotic system may include the tidying robot 100, the base station 300, a robotic control system 1000, and logic 1014 that when executed directs the robot to perform the disclosed method. When the tidying robot 100 is docked at a base station 300 having an object collection bin 302, the scoop 110 may be raised and rotated up and over the tidying robot 100 chassis 102, allowing tidyable objects 802 in the scoop 110 to drop into the storage compartment 304 of the object collection bin 302 to the rear 414 of the tidying robot 100 in a rear dump action 902, as is also described with respect to the raised scoop position and raised pusher position 400c and raised scoop position and raised pusher position 500c described with respect to FIG. 4C and FIG. 5C, respectively.

In a docked state, the robot charge connector 158 may electrically couple with the base station charge connector 310 such that electrical power from the power source connection 312 may be carried to the battery 160, and the battery 160 may be recharged toward its maximum capacity for future use.

When the tidying robot 100 docks at its base station 300, the dirt release latch 148 may lower, allowing the vacuum compartment 138 to interface with the vacuum emptying system 314. Where the vacuum emptying system intake port 316 is covered by a protective element, the dirt release latch 148 may interface with that element to open the vacuum emptying system intake port 316 when the tidying robot 100 is docked. The vacuum compartment fan 154 may remain inactive or may reverse direction, permitting or compelling airflow 904 through the vacuum compartment exhaust port 156, into the vacuum compartment 138, across the dirt collector 146, over the dirt release latch 148, into the vacuum emptying system intake port 316, through the vacuum emptying system filter bag 318, and out the vacuum emptying system exhaust port 324, in conjunction with the operation of the vacuum emptying system fan 320. The action of the vacuum emptying system fan 320 may also pull airflow 906 in from the vacuum compartment intake port 140, across the dirt collector 146, over the dirt release latch 148, into the vacuum emptying system intake port 316, through the vacuum emptying system filter bag 318, and out the vacuum emptying system exhaust port 324. In combination, airflow 904 and airflow 906 may pull dirt and dust from the dirt collector 146 into the vacuum emptying system filter bag 318, emptying the dirt collector 146 for future vacuuming tasks. The vacuum emptying system filter bag 318 may be manually discarded and replaced on a regular basis.

FIG. 10 depicts an embodiment of a robotic control system 1000 to implement components and process steps of the systems described herein. Some or all portions of the robotic control system 1000 and its operational logic may be contained within the physical components of a robot and/or within a cloud server in communication with the robot and/or within the physical components of a user's mobile computing device, such as a smartphone, tablet, laptop, personal digital assistant, or other such mobile computing devices. In one embodiment, aspects of the robotic control system 1000 on a cloud server and/or user's mobile computing device may control more than one robot at a time, allowing multiple robots to work in concert within a working space.

Input devices 1004 (e.g., of a robot or companion device such as a mobile phone or personal computer) comprise transducers that convert physical phenomena into machine internal signals, typically electrical, optical, or magnetic signals. Signals may also be wireless in the form of electromagnetic radiation in the radio frequency (RF) range but also potentially in the infrared or optical range. Examples of input devices 1004 are contact sensors which respond to touch or physical pressure from an object or proximity of an object to a surface, mice which respond to motion through space or across a plane, microphones which convert vibrations in the medium (typically air) into device signals, scanners which convert optical patterns on two or three-dimensional objects into device signals. The signals from the input devices 1004 are provided via various machine signal conductors (e.g., busses or network interfaces) and circuits to memory 1006.

The memory 1006 is typically what is known as a first- or second-level memory device, providing for storage (via configuration of matter or states of matter) of signals received from the input devices 1004, instructions and information for controlling operation of the central processing unit or processor 1002, and signals from storage devices 1010. The memory 1006 and/or the storage devices 1010 may store computer-executable instructions and thus forming logic 1014 that when applied to and executed by the processor 1002 implement embodiments of the processes disclosed herein. “Logic” refers to machine memory circuits and non-transitory machine readable media comprising machine-executable instructions (software and firmware), and/or circuitry (hardware) which by way of its material and/or material-energy configuration comprises control and/or procedural signals, and/or settings and values (such as resistance, impedance, capacitance, inductance, current/voltage ratings, etc.), that may be applied to influence the operation of a device. Magnetic media, electronic circuits, electrical and optical memory (both volatile and nonvolatile), and firmware are examples of logic. Logic specifically excludes pure signals or software per se (however does not exclude machine memories comprising software and thereby forming configurations of matter). Logic 1014 may include portions of a computer program, along with configuration data, that are run by the processor 1002 or another processor. Logic 1014 may include one or more machine learning models 1016 used to perform the disclosed actions. In one embodiment, portions of the logic 1014 may also reside on a mobile or desktop computing device accessible by a user to facilitate direct user control of the robot.

Information stored in the memory 1006 is typically directly accessible to the processor 1002 of the device. Signals input to the device cause the reconfiguration of the internal material/energy state of the memory 1006, creating in essence a new machine configuration, influencing the behavior of the robotic control system 1000 by configuring the processor 1002 with control signals (instructions) and data provided in conjunction with the control signals.

Second- or third-level storage devices 1010 may provide a slower but higher capacity machine memory capability. Examples of storage devices 1010 are hard disks, optical disks, large-capacity flash memories or other non-volatile memory technologies, and magnetic memories.

In one embodiment, memory 1006 may include virtual storage accessible through a connection with a cloud server using the network interface 1012, as described below. In such embodiments, some or all of the logic 1014 may be stored and processed remotely.

The processor 1002 may cause the configuration of the memory 1006 to be altered by signals in storage devices 1010. In other words, the processor 1002 may cause data and instructions to be read from storage devices 1010 in the memory 1006 which may then influence the operations of processor 1002 as instructions and data signals, and which may also be provided to the output devices 1008. The processor 1002 may alter the content of the memory 1006 by signaling to a machine interface of memory 1006 to alter the internal configuration and then converted signals to the storage devices 1010 alter its material internal configuration. In other words, data and instructions may be backed up from memory 1006, which is often volatile, to storage devices 1010, which are often non-volatile.

Output devices 1008 are transducers that convert signals received from the memory 1006 into physical phenomena such as vibrations in the air, patterns of light on a machine display, vibrations (i.e., haptic devices), or patterns of ink or other materials (i.e., printers and 3-D printers).

The network interface 1012 receives signals from the memory 1006 and converts them into electrical, optical, or wireless signals to other machines, typically via a machine network. The network interface 1012 also receives signals from the machine network and converts them into electrical, optical, or wireless signals to the memory 1006. The network interface 1012 may allow a robot to communicate with a cloud server 1022 containing logic 1014, a mobile device, other robots, and other network-enabled devices.

In one embodiment, a global database 1018 may provide data storage available across the devices that comprise or are supported by the robotic control system 1000. The global database 1018 may include maps, robotic instruction algorithms, robot state information, static, movable, and tidyable object reidentification fingerprints, labels, and other data associated with known static, movable, and tidyable object reidentification fingerprints, or other data supporting the implementation of the disclosed solution. The global database 1018 may be a single data structure or may be distributed across more than one data structure and storage platform, as may best suit an implementation of the disclosed solution. In one embodiment, the global database 1018 is coupled to other components of the robotic control system 1000 through a wired or wireless network, and in communication with the network interface 1012.

In one embodiment, a robot instruction database 1020 may provide data storage available across the devices that comprise or are supported by the robotic control system 1000. The robot instruction database 1020 may include the programmatic routines that direct specific actuators of the tidying robot, such as are described previously, to actuate and cease actuation in sequences that allow the tidying robot to perform individual and aggregate motions to complete tasks.

### Robot Using Washing Machine and Dryer

In some embodiments, a general purpose tidying robot moves laundry into a washing machine and then moves the laundry from the washing machine into the a dryer.

Moving Clothing Items into the Scoop

In an embodiment, the tidying robot picks up clothing off of a surface, such as a countertop or the floor. The pusher pads of the robot may first grip the clothing, lift is slightly up and then retract the pusher pad arms to move the clothing into the scoop.

As illustrated in FIG. 11A-FIG. 11D, a clothes gathering routine 1100 may include using a tidying robot to separate an item of clothing from a pile of clothing on a surface and grasp the item of clothing with pusher pads on the robot scoop, as shown in step 1102. In an embodiment, the item of clothing may optionally be lifted slightly up off of the surface, and then as seen at step 1104, the pusher pad arms may be retracted to move the item of clothing into the scoop and release the item into the scoop. In step 1106, the pusher pads are again extended to another item or items on the surface and are manipulated to grasp the item(s). In step 1108, the other item(s), in some embodiments, are slightly raised by the pusher pads and moved into the scoop by retracting the pusher pad arms.

In some embodiments, the robot's perception, mapping and localization algorithms are running in the background typically at around 10+ frames per second (FPS). As a result, the environment is mapped, the robot is localized and objects of interest are positioned on the map with a panoptic segmentation model, sensor fusion algorithms (e.g., fusing LIDAR), and other perception algorithms.

In some embodiments, when the robot encounters an item of clothing that it wants to pick up and move into the scoop it may use the following routine. Typically it is assumed that the scoop is empty, but some strategies may allow multiple small/medium objects together in the scoop for improved efficiency.
1. Determine the support surface where the target object (e.g., clothing item) is placed (e.g., floor/table/chair/couch/bed), and whether that support surface is flat.
2. Determine whether the object (e.g., clothing item) is unconstrained and free to pick up with a known strategy, or whether it is likely going to be stuck or hooked on something (e.g., another object can't be on top).
3. Determine the scoop size & configuration needed to accommodate the object (e.g., clothing item) and the pickup environment. E.g., does the scoop need to expand, and do the side walls need to fold under? Scoop may need to shrink to fit in narrow spaces.
4. Determine the optimal positioning of the scoop relative to the target object (e.g., clothing item) in order to enable an effective pickup strategy.
5. Determine whether the scoop is empty, or if there is sufficient space in the scoop to accommodate the target object (e.g., clothing item).
6. Execute the robot pre-positioning strategy:
   Adjusting scoop size to accommodate target object & pickup environment
   Positioning robot staged near target object
   Positioning scoop adjacent to target object
1. Generate manipulation points for the target object (e.g., clothing item) such as grip points and pusher pad alignment points.
2. A movement strategy executes in order to grip, push and move the target object (e.g., clothing item) into the scoop. In some embodiments this may be a machine learning based strategy (e.g., with reinforcement learning or imitation learning), or it may be a rule/heuristic based strategy. Collision detection & safety algorithms may be running in the background to make sure strategies do not result in collisions.
3. Steps 7 and 8 may repeat until the object is fully picked up. For example, if the object is only partially pushed into the scoop then it may be re-grasped, or re-pushed to further move it.
   Strategies may often involve push grasping with one arm, and pushing with the other arm. This combined push/pull strategy helps lift the target object up over the scoop lip reducing friction while also pushing it from behind so that it goes more fully into the scoop.

### Loading Clothing Items in the Washing Machine

In an embodiment, the tidying robot carries clothing in the scoop while navigating to the washing machine. The tidying robot then opens the door of the washing machine and deposits items of clothing into the washing machine.

FIG. 12A-FIG. 12F illustrate, in one embodiment, a washer loading routine 1200 including transporting, using a tidying robot, clothing in a scoop to a washing machine at step 1202. The items of clothing may be carried in a scoop that is leaning backwards toward the back of the robot. In other embodiments, the pusher pads of the robot assist in keeping the clothing in the scoop during transport. In some embodiments, upon arriving at the washing machine, a gripper arm 1214 of the tidying robot grasps a washing machine door handle 1216 as demonstrated in step 1204. The gripper arm may then be retracted, or the tidying robot may move backwards, to open the door of the washing machine as demonstrated in step 1206. Next, in step 1208, the tidying robot may move the gripper arm away from the front of the scoop, move closer to the entrance of the washing machine, and place the items of clothing into the washing machine. This may be accomplished by dumping the items of clothing with the scoop being tilted forward until the clothes fall into the washing machine. In some embodiments, the items of clothing may be grasped by the pusher pads and placed into the washing machine. In another embodiments, the pusher pads may be used to push the items of clothing off of the scoop and into the washing machine. As demonstrated in step 1210-step 1212, the gripper arm may be used to close the washing machine door by again grasping a portion of the door in step 1210 and either extending the arm, or by pushing the door closed in step 1212 while the tidying robot moves forward. In an embodiment, the tidying robot may initiate a washing cycle by wirelessly communicating with the washing machine or by pressing a button on the washing machine with the gripper arm. In a further embodiment, the washing machine may dispense detergent into the washing area and begin the washing cycle.

Unloading Clothing Items from the Washing Machine

In an embodiment, the tidying robot opens the washer drawer and moves the washed clothes to the dryer.

FIG. 13A-FIG. 13H illustrate the steps of unloading the washing machine and loading the dryer according to several embodiments. After the items of clothing have been cleaned in the washing machine, in step 1302, the tidying robot approaches the dryer and opens the door using the dryer door handle 1218 and the gripper arm 1214. In an embodiment, the tidying robot may open the dryer door after removing the items of clothing from the washer. Next, in step 1304, the gripper arm may open the washer door to remove the washed items of clothing. In some embodiments, as shown in step 1306, the scoop is slightly tilted forward and placed at the entrance of the washing machine. In some embodiments, the pusher pads are extended into the washing machine and are used to grasp the items of clothing, followed by step 1308, where the pusher pads may pull them into the scoop. In some embodiments, the scoop may need to be tilted downwards initially if the washing machine door is somewhat narrow, so that the pusher pads can reach the bottom of the washing machine. Next, according to some embodiments, the scoop may be tilted back as seen in step 1310. In some embodiments, only a portion of the items of clothing in the washing machine are transferred onto the scoop to be carried to the dryer, requiring multiple trips between the washing machine and the dryer to transfer all of the items of clothing. The items of clothing in the scoop may be carried to the dryer. If the dryer is directly below the washing machine, then the scoop lift of the tidying robot may lower the scoop to the opening of the dryer and tilt the scoop forward, as seen in step 1312. If the dryer is not directly below the washing machine, then the tidying robot may drive to the dryer before partially placing the scoop into the dryer. Next, in some embodiments as illustrated in step 1314, the items of clothing may be placed in a dryer door opening in the dryer using the pusher pads. In some embodiments, gravity may cause the items of clothing to slide into the dryer when the scoop is tilted forward. After the items of clothing have been placed in the dryer, the gripper arm may be used to close the door of the dryer. In some embodiments, the tidying robot may initiate a drying cycle by communicating wirelessly with the dryer or pressing a button on the dryer with the gripper arm.

In FIG. 13I, a step 1318 is shown for an unloading process if the washing machine is a top-loading machine. In an embodiment, after opening the lid, the pusher pads 1322 reach into the top-loading washer 1320 through the top. The pusher pads 1322 then grab clothes, lift out the clothes, and deposit the clothes onto the scoop 1328. In some embodiments, the pusher pads 1322 may have end effectors 1326 at the ends of the pads. In exemplary embodiments, these may be grippers, also known as fabric grippers and pinch grippers. Additionally, shoulder joint actuators 1330 may assist in maneuvering the pusher pads 1322 into the top-loading washer 1320. In some embodiments, having grippers at the end of the pusher pad arms 1324 would be helpful in grasping individual items (e.g., a sock) that would be left behind. In some embodiments, the pusher pad arms 1324 are used to grab and move a bulk of the laundry, but end effectors 1326 may also be used to handle picking up individual clothing items after the bulk is moved.

Unloading Clothing Items from the Dryer

In an embodiment, the tidying robot opens the washing machine door and moves the washed clothes to the dryer.

FIG. 14A-FIG. 14F illustrate the steps of unloading clothes from the dryer and transporting the clothes to a location for sorting and/or folding. After the clothes have been dried in the dryer, in step 1402, the tidying robot approaches the dryer and opens the door. In an embodiment, the tidying robot may open the dryer door using the gripper arm. Next, in some embodiments, as shown in step 1404, the scoop is slightly tilted forward and placed at the dryer door opening of the dryer. In some embodiments, the scoop may be placed partially through the dry door opening. In some embodiments, the pusher pads are extended into the dryer and are used to grasp the clothes, followed by step 1406, where the pusher pads may pull them onto the scoop. In some embodiments, the scoop may need to be tilted downwards initially if the dryer door is somewhat narrow, so that the pusher pads can reach the bottom of the dryer, as seen in step 1408. In some embodiments, only a portion of the clothes in the dryer are transferred into in the scoop to be carried to a different location, requiring multiple trips between the dryer and the location to transfer all of the clothes. The clothes in the scoop may be carried to the different location where the scoop is placed above a surface. Next, an some embodiments as illustrated in step 1410, the scoop may be tilted forward. In step 1412, the clothes may be placed on the surface by using the pusher pads. In some embodiments, gravity may cause the clothes to slide onto the surface when the scoop is tilted forward. After the clothes have been placed on the surface, the surface may be used to assist in sorting and folding the clothing.

Moving Clothing Items from the Scoop on to a Flat Surface

In some embodiments, following completion of the drying cycle and removal of the clothes from the dryer, the robot may transport the dry clothes to a location to be sorted and/or folded. In some embodiments, the robot's perception, mapping and localization algorithms are running in the background typically at around 10+ FPS. As a result, the environment may be mapped, the robot is localized and objects of interest are positioned on the map with a panoptic segmentation model, sensor fusion algorithms (E.g. fusing LIDAR), and other perception algorithms.

When the robot is carrying items of clothing that it wants to sort and fold it may use the following routine according to some embodiments. During initial setup the owner may choose a designated folding surface, and may optionally choose to have the robot pre-wipe the surface clean before sorting and folding. There may also be a setting on how different types of obstructions to that surface should be handled. (e.g., how should the robot handle a freshly baked pie on the counter that it wanted to use for folding?)
1. Navigate to the designated folding surface. If the user has not selected a designated folding surface the robot may auto-select an appropriate surface to use as a default.
2. Determine whether the designated folding surface is free of obstructions. If there are obstructions then the robot may follow a routine to clear the obstructions based on the user's instructions.
3. Determine whether the designated folding surface is known to be clean. If not, the robot may use the accessory gripper to take a cleaning pad and wipe the surface clean.
4. Determine the optimal positioning of the scoop relative to the designated folding surface in order to effectively place items on that surface, and leave room for folding.
5. Execute the robot pre-positioning strategy:
   Positioning robot staged near designated folding surface
   Positioning scoop adjacent to (or on) designated folding surface
1. Generating manipulation points for items in the scoop and on the designated folding surface for the transfer of items from the scoop to the folding surface.
2. Executing a movement strategy in order to dump, push grip, and move the items (e.g., clothing items) from the scoop to the designated folding surface. This may be a machine learning based strategy (e.g., with reinforcement learning or imitation learning), or it may be a rule/heuristic based strategy. Collision detection & safety algorithms may be running in the background to make sure strategies do not result in collisions.
3. Steps 6 and 7 may repeat until the target objects are fully moved onto the designated folding surface. For example, if an object is stuck in the scoop it may be grasped and/or pushed out to further move it.
   Strategies may simply involve dumping the scoop at a steep angle in order to drop items onto the surface, but in some embodiments, strategies may also be used that combine tilting the scoop slightly, grasping with one arm and pushing with another to more gradually & carefully move items out of the scoop.

### Keypoint Based Manipulation of Objects

When manipulating objects with the general purpose tidying robot such as having it fold clothing or opening appliance doors, the robot may often use a deep learning model to generate key points for specifically manipulating certain objects, often alongside panoptic segmentation, which labels both whole objects and their individual parts. In some embodiments, these tasks are commonly handled by a single model with a shared backbone and multiple output heads, such as one for segmentation and another for key point detection, enabling efficient joint inference.

In particular, these manipulation key points may often differ from visual key points in that for example the correct fold points on clothing may often simply be along an edge a certain distance from a corner where the corner is visually distinctive, but the fold point is not visually unique.

### Core Perception Modules

Segmentation: identify objects and their parts (e.g., shirt vs. sleeve).
Landmarks: detect distinctive points (e.g., corners, handles, rims).
Affordance heatmaps: highlight where actions are possible (grip, hold, push, align).
Keypoint solver: select specific contact points, respecting constraints (offset from corner, symmetry, opposing sides).

Task Configuration (Recipes) Each task is defined as a recipe made of steps. A step specifies:
Action type (grip, hold, lift, align).
Target object/part (shirt hem, pant leg, pot lid).
Constraints (e.g., “on edge,” “10 cm from corner,” “symmetric pair”).
End-effector type (gripper, scoop, pad).
Next step (what follows once this action is done).

This separates what to do (recipe) from how to see and act (perception+solver).

### Control & Planning.

Step planner: reads the current step from the recipe.
Motion planner: turns chosen key points into robot motions.
State updater: records progress (which folds done, whether lid removed, etc.).

Learning Loops (Continuous Improvement) The robot improves over time using three complementary approaches:
1. Imitation Learning (IL)
   Learn initial behaviors from human demonstrations.
   Fast way to bootstrap skills.
1. Self-Supervised Learning
   Robot interacts with objects and learns from the outcomes (e.g., pulling on cloth to see how it moves).
   Improves perception and generalization without human labels.
1. Reinforcement & Human Corrections
   Rewards from task success (e.g., neat fold, stable pot lift).
   Human corrections can guide the robot without giving full new demos.
   Refines skills beyond what was demonstrated.

### Runtime Workflow

1. Perception: segmentation, landmarks, affordances.
2. Step selection: read the next step from the recipe.
3. Keypoint solver: pick exact manipulation points under step constraints.
4. Motion execution: plan and perform the action.
5. Feedback: log success/failure; use for imitation, self-supervised, or RL updates.
6. Advance to next step until task is complete.

### Summary

Configurable: new tasks only require a new recipe file.
Reusable perception: segmentation, landmarks, affordances work across tasks.
Improves over time: imitation to start, self-supervision for generalization, reinforcement/corrections for refinement.
Step-wise execution: robot only focuses on the next action, reducing complexity.

### Example Config

task: carry_pot steps:—step: place_lift_pads action: hold target: pot_rim constraints: {two_points_opposite: true} end_effector: pads next: remove_lid-step: remove_lid action: grip target: pot_lid_knob constraints: {landmark: knob} end_effector: gripper next: align_lid-step: align_lid action: align target: pot_rim constraints: {align_points: [rim_point1, rim_point2]} end_effector: gripper next: done
task: fold_pants steps:—step: fold_leg_over action: grip target: pant_leg constraints: {fold_over: other_leg} end_effector: gripper next: fold_ankles_up-step: fold_ankles_up action: grip target: pant_ankles constraints: {fold_towards: waist} end_effector: gripper next: optional_stack-step: optional_stack action: grip target: folded_pants constraints: {fold_towards: half_height} end_effector: gripper next: done
task: fold_shirt steps:—step: fold_left_side action: grip target: shirt_hem constraints: {offset_from_corner: 10 cm, edge_aligned: true} end_effector: gripper next: fold_right_side-step: fold_right_side action: grip target: shirt_hem constraints: {symmetric_to: fold_left_side} end_effector: gripper next: fold_bottom-step: fold_bottom action: grip target: shirt_hem constraints: {fold_towards: collar} end_effector: gripper next: done

### Segmentation

What: Split the image into objects and their parts, for example shirt body and sleeves, or pot and lid.
Why: Actions target specific parts, so the robot needs clear masks and edges.

### Landmarks

What: Distinctive points on the object such as corners, handles, or rim points.
Why: They provide anchors for actions like “grip 10 cm from this corner” even if the exact grip point is not visually unique.

### Affordance Heatmaps

What: A map showing which regions are suitable for an action like grip, hold, push, or align.
Why: They highlight feasible zones for the current step, helping the robot focus on where the action will succeed.

### Keypoint Solver

What: A module that converts landmarks and affordance maps into precise contact points and orientations.
Why: It enforces constraints such as “on an edge,” “a fixed offset from a landmark,” “symmetric pairs,” or “two opposing contact points,” ensuring the chosen keypoints are physically valid and task-appropriate.
   How they Work Together
Segmentation isolates the correct part of the object.
Landmarks identify reference anchors.
Affordance maps highlight suitable regions.
The Keypoint solver selects the exact contact points that satisfy the step's constraints.

The backbone (for example a CNN) processes the image once to extract general visual features. Multiple heads branch from it:
Segmentation head: Predicts object and part masks.
Landmark head: Predicts anchor points such as corners or handles.
Affordance head: {redicts heatmaps showing where specific actions are possible.
Keypoint solver is either:
   A separate solver module that applies explicit rules and constraints (for example “choose a point on the hem edge offset from a corner” or “pick two sym metric points”)
   A neural head that directly predicts key points from shared features, possibly combined with a lightweight solver to enforce constraints.

This setup is efficient because the robot only runs one forward pass through the backbone, and all perception tasks share the same features. It also helps the model learn better, since tasks like segmentation, landmarks, and affordances reinforce each other.

In some embodiments as shown in FIG. 15, the use of key point manipulation 1500 is used for manipulating a washer and dryer combo. Key points are shown on a washer 1502 and a dryer 1512 identifying the washer handle grip points 1506 of the washer door 1504 and the dryer handle grip points 1516 of the dryer door 1514 where the gripper should grasp the handle. Additionally, in some embodiments, washer hinge points 1508 and dryer hinge points 1518 are also identified. In some embodiments, washer close points 1510 and dryer close points 1520 may further be identified. In some embodiments, the identification of the hinge points and close points may allow the motion of the dryer door 1514 and the washer door 1504 to be modelled effectively for manipulation, since the arc of rotation is known from these key points.

FIG. 16 illustrates an example method 1600 for using a tidying robot to load a washing machine. Although the example method 1600 depicts a particular sequence of operations, the sequence may be altered without departing from the scope of the present disclosure. For example, some of the operations depicted may be performed in parallel or in a different sequence that does not materially affect the function of the method 1600. In other examples, different components of an example device or system that implements the method 1600 may perform functions at substantially the same time or in a specific sequence.

According to some examples, the method includes approaching a washing machine with a tidying robot carrying items of clothing to be washed in a scoop at block 1602.

According to some examples, the method includes grasping a washing machine door handle on a washing machine door with the gripper arm at block 1604.

According to some examples, the method includes opening the washing machine door with the gripper arm at block 1606.

According to some examples, the method includes placing at least a portion of the scoop into the washing machine door opening at block 1608.

According to some examples, the method includes placing the items of clothing into the washing machine at block 1610.

According to some examples, the method includes closing the washing machine door with the gripper arm at block 1612.

FIG. 17 illustrates an example method 1700 for sorting clothes and loading clothes onto the scoop of a tidying robot.

According to some examples, the method includes separating, with the pusher pads, an item of clothing from a pile of clothing located on a surface at block 1702.

According to some examples, the method includes grasping, with the pusher pads, the item of clothing at block 1704.

According to some examples, the method includes retracting the pusher pad arms to move the item of clothing into the scoop at block 1706.

According to some examples, the method includes releasing the item of clothing into the scoop at block 1708.

According to some examples, the method includes extending the pusher pad arms to the pile of clothing at block 1710.

According to some examples, the method includes grasping, with the pusher pads, an additional item of clothing at block 1712.

According to some examples, the method includes retracting the pusher pad arms to move the additional item of clothing into the scoop at block 1714.

FIG. 18 illustrates an example method 1800 for generating key points.

According to some examples, the method includes generating key points for manipulating the washing machine door and a dryer door, at block 1802.

According to some examples, the method includes manipulating at least one of the key points to open or close the washing machine door or the dryer door at block 1804.

According to some examples, the method includes modeling a motion of the washing machine door or the dryer door using the at least one key points at block 1806.

FIG. 19 illustrates an example method 1900 for loading a dryer with the tidying robot.

According to some examples, the method includes opening a dryer door with the gripper arm at block 1902.

According to some examples, the method includes approaching the washing machine containing the washed items of clothing inside at block 1904.

According to some examples, the method includes grasping a washing machine door handle on a washing machine door and opening the door with the gripper arm at block 1906.

According to some examples, the method includes placing at least a portion of the scoop into the washing machine door opening at block 1908.

According to some examples, the method includes placing the washed items of clothing onto the scoop utilizing the pusher pads at block 1910.

According to some examples, the method includes carrying the scoop with washed items of clothing to a dryer door opening at block 1912.

According to some examples, the method includes placing the washed items of clothing into the dryer at block 1914.

According to some examples, the method includes closing the dryer door with the gripper arm at block 1916.

FIG. 20 illustrates an example method 2000 for unloading the dryer with the tidying robot.

According to some examples, the method includes grasping the dryer door handle, after the washed items of clothing have been dried, with the gripper arm at block 2002.

According to some examples, the method includes opening the dryer door with the gripper arm at block 2004 after the washed items of clothing have been subjected to a drying cycle.

According to some examples, the method includes placing at least a portion of the scoop into the dryer door opening at block 2006.

According to some examples, the method includes placing dried items of clothing onto the scoop utilizing the pusher pads at block 2008.

According to some examples, the method includes carrying the scoop with dried items of clothing to a desired location at block 2010.

According to some examples, the method includes placing the scoop with dried items of clothing above a surface at the desired location at block 2012.

According to some examples, the method includes placing the dried items of clothing onto the surface at block 2014.

Various functional operations described herein may be implemented in logic that is referred to using a noun or noun phrase reflecting said operation or function. For example, an association operation may be carried out by an “associator” or “correlator”. Likewise, switching may be carried out by a “switch”, selection by a “selector”, and so on. “Logic” refers to machine memory circuits and non-transitory machine readable media comprising machine-executable instructions (software and firmware), and/or circuitry (hardware) which by way of its material and/or material-energy configuration comprises control and/or procedural signals, and/or settings and values (such as resistance, impedance, capacitance, inductance, current/voltage ratings, etc.), that may be applied to influence the operation of a device. Magnetic media, electronic circuits, electrical and optical memory (both volatile and nonvolatile), and firmware are examples of logic. Logic specifically excludes pure signals or software per se (however does not exclude machine memories comprising software and thereby forming configurations of matter).

Within this disclosure, different entities (which may variously be referred to as “units,” “circuits,” other components, etc.) may be described or claimed as “configured” to perform one or more tasks or operations. This formulation-[entity] configured to [perform one or more tasks]—is used herein to refer to structure (i.e., something physical, such as an electronic circuit). More specifically, this formulation is used to indicate that this structure is arranged to perform the one or more tasks during operation. A structure may be said to be “configured to” perform some task even if the structure is not currently being operated. A “credit distribution circuit configured to distribute credits to a plurality of processor cores” is intended to cover, for example, an integrated circuit that has circuitry that performs this function during operation, even if the integrated circuit in question is not currently being used (e.g., a power supply is not connected to it). Thus, an entity described or recited as “configured to” perform some task refers to something physical, such as a device, circuit, memory storing program instructions executable to implement the task, etc. This phrase is not used herein to refer to something intangible.

The term “configured to” is not intended to mean “configurable to.” An unprogrammed field programmable gate array (FPGA), for example, would not be considered to be “configured to” perform some specific function, although it may be “configurable to” perform that function after programming.

Reciting in the appended claims that a structure is “configured to” perform one or more tasks is expressly intended not to invoke 35 U.S.C. § 112 (f) for that claim element. Accordingly, claims in this application that do not otherwise include the “means for” [performing a function] construct should not be interpreted under 35 U.S.C § 112 (f).

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

As used herein, the phrase “in response to” describes one or more factors that trigger an effect. This phrase does not foreclose the possibility that additional factors may affect or otherwise trigger the effect. That is, an effect may be solely in response to those factors, or may be in response to the specified factors as well as other, unspecified factors. Consider the phrase “perform A in response to B.” This phrase specifies that B is a factor that triggers the performance of A. This phrase does not foreclose that performing A may also be in response to some other factor, such as C. This phrase is also intended to cover an embodiment in which A is performed solely in response to B.

As used herein, the terms “first,” “second,” etc. are used as labels for nouns that they precede, and do not imply any type of ordering (e.g., spatial, temporal, logical, etc.), unless stated otherwise. For example, in a register file having eight registers, the terms “first register” and “second register” may be used to refer to any two of the eight registers, and not, for example, just logical registers 0 and 1.

When used in the claims, the term “or” is used as an inclusive or and not as an exclusive or. For example, the phrase “at least one of x, y, or z” means any one of x, y, and z, as well as any combination thereof.

As used herein, a recitation of “and/or” with respect to two or more elements should be interpreted to mean only one element or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Having thus described illustrative embodiments in detail, it will be apparent that modifications and variations are possible without departing from the scope of the disclosure as claimed. The scope of inventive subject matter is not limited to the depicted embodiments but is rather set forth in the following Claims.

What is claimed is:

1. A method comprising:
approaching a washing machine with a tidying robot carrying items of clothing to be washed in a scoop, wherein the tidying robot includes:
a chassis with at least one of at least one wheel and at least one track for mobility of the tidying robot;
the scoop mounted on the tidying robot;
pusher pads mounted on pusher pad arms, the pusher pad arms attached to the scoop and configured to move the pusher pads into a position to grasp the items of clothing;
a gripper arm attached to the scoop and configured to grasp items;
grasping a washing machine door handle on a washing machine door with the gripper arm;
opening the washing machine door with the gripper arm;
moving the scoop closer to a washing machine door opening of the washing machine;
placing at least a portion of the scoop into the washing machine door opening;
placing the items of clothing into the washing machine; and
closing the washing machine door with the gripper arm.

2. The method of claim 1, further comprising:
initiating, by the tidying robot, a washing cycle by wirelessly communicating with the washing machine.

3. The method of claim 1, further comprising:
initiating, by the tidying robot, a washing cycle by pressing a button on the washing machine using the gripper arm.

4. The method of claim 1, wherein placing the items of clothing into the washing machine includes:
tilting the scoop forward and allowing the items of clothing to slide into the washing machine.

5. The method of claim 1, wherein placing the items of clothing into the washing machine includes:
tilting the scoop forward; and
at least one of:
grasping the items of clothing with the pusher pads and placing the items of clothing into the washing machine; and
pushing, with the pusher pads the items of clothing into the washing machine.

6. The method of claim 1, further comprising a clothes gathering routine including:
separating, with the pusher pads, an item of clothing from a pile of clothing located on a surface;
grasping, with the pusher pads, the item of clothing;
retracting the pusher pad arms to move the item of clothing into the scoop;
releasing the item of clothing into the scoop;
extending the pusher pad arms to the pile of clothing;
grasping, with the pusher pads, an additional item of clothing; and
retracting the pusher pad arms to move the additional item of clothing into the scoop.

7. The method of claim 1, further comprising:
generating key points for manipulating the washing machine door and a dryer door, wherein the key points include at least one of:
a washer handle grip point;
washer hinge points;
washer close points;
a dryer handle grip point;
dryer hinge points; and
dryer close points; and
manipulating at least one of the key points to open or close the washing machine door or the dryer door.

8. The method of claim 7, further comprising modeling a motion of the washing machine door or the dryer door using the at least one key points.

9. The method of claim 7, further using panoptic segmentation to label at least one of:
the washing machine and individual parts of the washing machine; and
the dryer and individual parts of the dryer.

10. The method of claim 1, further comprising:
opening a dryer door on a dryer with the gripper arm;
approaching the washing machine containing the washed items of clothing inside, with the tidying robot;
grasping the washing machine door handle on the washing machine door with the gripper arm;
opening the washing machine door with the gripper arm;
moving the scoop closer to the washing machine door opening of the washing machine;
placing at least a portion of the scoop into the washing machine door opening;
placing the washed items of clothing onto the scoop utilizing the pusher pads;
removing the scoop from the washing machine door opening;
carrying the scoop with washed items of clothing to a dryer door opening;
placing the scoop with washed items of clothing at least partially through the dryer door opening;
tilting the scoop with washed items of clothing forward;
placing the washed items of clothing into the dryer;
removing the scoop from the dryer; and
closing the dryer door with the gripper arm.

11. The method of claim 10, further comprising:
initiating, by the tidying robot, a drying cycle by wirelessly communicating with the dryer.

12. The method of claim 10, initiating, by the tidying robot, a drying by pressing a button on the dryer using the gripper arm.

13. The method of claim 10, wherein placing the washed items of clothing into the dryer includes:
tilting the scoop forward and allowing the items of clothing to slide into the dryer.

14. The method of claim 10, wherein placing the washed items of clothing into the dryer includes:
tilting the scoop forward; and
at least one of:
grasping the washed items of clothing with the pusher pads and placing the washed items of clothing into the dryer; and
pushing, with the pusher pads the washed items of clothing into the dryer.

15. The method of claim 10, further comprising:
grasping the dryer door handle, after the washed items of clothing have been subjected to a drying cycle, with the gripper arm;
opening the dryer door with the gripper arm;
moving the scoop closer to the dryer door opening of the dryer;
placing at least a portion of the scoop into the dryer door opening;
placing dried items of clothing onto the scoop utilizing the pusher pads;
removing the scoop from the dryer door opening;
carrying the scoop with dried items of clothing to a desired location.

16. The method of claim 15, further comprising:
placing the scoop with dried items of clothing above a surface at the desired location;
tilting the scoop forward; and
placing the dried items of clothing onto the surface.

17. The method of claim 16, wherein placing the dried items of clothing onto the surface includes:
allowing the dried items of clothing to slide onto the surface.

18. The method of claim 16, wherein placing the dried items of clothing onto the surface includes:
at least one of:
grasping the dried items of clothing with the pusher pads and placing the dried items of clothing onto the surface; and
pushing, with the pusher pads the dried items of clothing onto the surface.
